(19) United States
(12) Patent Application Publication
(10) Pub. No.: US 2024/0219166 A1
(43) Pub. Date: Jul. 4, 2024

(54) METHOD OF DIAGNOSING, AND A SENSOR DEVICE WITH SELF-DIAGNOSTIC FUNCTION

(71) Applicant: Melexis Technologies SA, Bevaix (CH)

(72) Inventors: Sébastien LEROY, Bevaix (CH); Lionel TOMBEZ, Bevaix (CH)

(21) Appl. No.: 18/539,586

(22) Filed: Dec. 14, 2023

(30) Foreign Application Priority Data
Dec. 31, 2022 (EP) 22217443.5

(51) Int. Cl. G01B 7/30

(52) U.S. Cl. CPC G01B 7/30

(57) ABSTRACT

A method of testing a sensor device includes a single angle calculator and at least two magnetic sensor elements. The method includes the steps of: a) obtaining signals from the sensor elements; b) amplifying and digitizing the signals from the sensor elements; c) applying a first input value IN1 derived from the digitized signal, to the angle calculator, to obtain a first angle value; d) applying a second input value IN2 derived from the digitized signal, to the angle calculator, to obtain a second angle value; e) performing a consistency test of the first and second angle value; f) detecting an error of the sensor device or the angle calculator based on an outcome of the consistency test.

### FIELD OF THE INVENTION

The present invention relates in general to the field of sensor devices having self-diagnostics or self-test capabilities, and more in particular to sensor devices (e.g. magnetic sensor devices) having an angle calculator (e.g. a single angle calculator) and capabilities to detect an error of that angle calculator. The present invention also relates to methods of testing such a sensor device, and to systems using such a sensor device.

### BACKGROUND OF THE INVENTION

Electronic components are being heavily used in automotive applications, not only for entertainment purposes (such as e.g. music), or assistance functions (such as e.g. electric mirror, or parking assistance), electronic sensors are also being used for steering assistance, engine control, and other safety-related functions. Evidently, the requirements in terms of reliability and system availability for such functions continues to increase, and safety standards (such as e.g. the SIL standard) are being developed, while at the same time pressure on costs remains high.

In order to meet safety standards, such as for example ASIL standards (“Automotive safety integrity level”) or other safety standards in the automotive field, it is desired to implement and use corresponding self-tests, including built-in self-tests, not only at start-up but also during normal operation, as well as automatic monitoring structures or corresponding redundant functional blocks and/or signal paths.

Conventional sensor systems, in particular magnetic sensor systems, use a single-channel analog main signal path. Other conventional solutions use two identical sensors and processing paths to meet ASIL requirements. Obviously, a considerable drawback of such solutions is the corresponding doubling of the cost for providing not only one but two sensors and processing circuitry.

US2012074972 discloses a monolithic integrated circuit sensor system comprising a first sensor device having a first signal path for a first sensor signal on a semiconductor chip; and a second sensor device having a second signal path for a second sensor signal on the semiconductor chip, the second signal path being distinct from the first signal path, wherein a comparison of the signal from the first signal path and the signal from the second signal path provides a sensor system self-test.

There is always room for improvements or alternatives.

### SUMMARY OF THE INVENTION

It is an object of embodiments of the present invention to provide a method of testing or detecting an error of a sensor device having an angle calculator and having at least one or at least two sensors.

It is also an object of embodiments of the present invention to provide a sensor device having an angle calculator and capabilities to detect an error of that angle calculator.

It is an object of embodiments of the present invention to provide a method of testing or detecting an error of a magnetic sensor device having a single angle calculator and having at least two magnetic sensors or having at least two groups of magnetic sensors.

It is an object of embodiments of the present invention to provide a method and a sensor device that is capable of detecting a fault condition during normal operation of the sensor device.

It is an object of embodiments of the present invention to provide a sensor device having only one angle calculator, and a method of testing that single angle calculator.

It is an object of embodiments of the present invention to provide a method of detecting an error in a more reliable way, e.g. using a method that also works for fast-changing input signals.

It is an object of embodiments of the present invention to provide a simple solution, e.g. with minimal additional circuitry (e.g. in terms of redundancy), and/or with minimal added complexity.

It is an object of particular embodiments of the present invention to provide a method and a sensor device for testing not only the angle calculator, but also a divider and/or a multiplier and/or an absolute_value function comprised in the sensor device.

It is also an object of embodiments of the present invention to provide a magnetic position system comprising such a sensor device and a permanent magnet.

These and other objectives are accomplished by embodiments of the present invention.

According to a first aspect, the present invention provides a method of testing an angle calculator implemented in a magnetic position sensor device that comprises at least a first and a second magnetic sensor element and a single angle calculator, the method comprising the steps of: a) obtaining a first signal provided by at least the first magnetic sensor element, and obtaining a second signal provided by at least the second magnetic sensor element; b) amplifying and digitizing the first signal to obtain a first digital signal (e.g. s1), and amplifying and digitizing the second signal to obtain a second digital signal (e.g. s2); c) deriving a first input value or a first set of input values (e.g. IN1) from said first and second digital signal (e.g. s1, s2), and applying this first input value or this first set of input values to the angle calculator, and obtaining a first angle value (e.g. a) from the angle calculator; d) deriving a second input value or a second set of input values (e.g. IN2) from said first and second digital signal (e.g. s1, s2), and applying this second input value or this second set of input values to the angle calculator, and obtaining a second angle value (e.g. β) from the angle calculator, wherein the first and second input value or the first set and the second set of input values (e.g. IN1, IN2) have a first predefined mathematical relationship; e) performing a consistency test of the first angle value (e.g. α) and the second angle value (e.g. β) based on a second predefined mathematical relationship, associated with the first predefined relationship; f) detecting an error of the single angle calculator based on an outcome of the consistency test.

The “angle calculator” may be referred to as an “angle calculator circuit” (e.g. when mainly implemented in hardware) or may be referred to as an “angle calculator module” (e.g. when mainly implemented in software) or may be implemented partially in hardware and partially in software (e.g. using a look-up table with linear interpolation).

It is noted that the sensor device may perform steps a) to c) periodically, e.g. once in each time period, but the steps d) to f) do not need to be performed in each time period. Whether steps d) to f) are performed or not, may be predetermined (e.g. once per 5 time periods, or once per 10 or 15 or 20 or 25 or 50 or 100 or 200 or 500 time periods), and/or may depend on the at least one digitized signal (e.g. is skipped if the digitized signal has an absolute value larger than a predetermined value).

As is well known in the art, an angle value can be expressed in radians or in degrees, e.g. a right angle corresponds to π/2 rad and 90°.

The angle calculator is preferably a digital angle calculator.

In an embodiment, the second input value (IN2) may be obtained using a reversible predefined transformation of the first input value, e.g. based on the formula f(x)=1/x.

In an embodiment, the first set of input values (IN1) is a first pair of values, and the second set of input values (IN2) is a second pair of values, e.g. by reversing the order of the two values, or e.g. having numerical values different from those of the first pair.

In an embodiment, the method further comprises outputting the first angle value (α) by the magnetic sensor device to another processing device (e.g. an ECU).

In an embodiment, the method further comprises outputting the first angle value (α) and the second angle (β) by the magnetic sensor device to another processing device (e.g. an ECU).

In an embodiment, the method further comprises outputting the first angle value (α) and a diagnostic signal indicative of an error being detected by the magnetic sensor device to another processing device (e.g. an ECU).

In an embodiment, the angle calculator is configured to estimate or to determine an arctangent function with one argument or an arctangent function with two arguments.

The arctangent function with one argument is typically written as arctan( ). The arctangent function with two arguments is typically written as arctan 2( ) or a tan 2( ). These “functions” may be implemented in the analog domain, or the digital domain, e.g. by evaluating a polynomial expression, or using a look-up table with or without interpolation, or using an iterative approach.

In an embodiment, step b) further comprises: storing the first digital signal (e.g. s1) in a first data register, and storing the second digital signal (e.g. s2) in a second data register; and wherein the first input value or the first set of input values (e.g. IN1) of step c), and the second input value or the second set of input values (e.g. IN2) of step d) are derived from the same numerical values as those stored in the first and second data register.

In an embodiment, the angle calculator comprises a divider and an arctangent calculator; and step c) comprises: calculating the first input value (e.g. IN1) by dividing the first digital signal (e.g. s1) by the second digital signal (e.g. s2), and providing the first input value (e.g. IN1) to the arctangent calculator for calculating the first angle value (e.g. α); and step d) comprises: calculating the second input value (e.g. IN2) by dividing the second digital signal (e.g. s2) by the first digital signal (e.g. s1), and providing the second input value (e.g. IN2) to the arctangent calculator for calculating the second angle value (e.g. β); and step e) comprises: testing whether a sum of the first angle value (e.g. α) and the second angle value (e.g. β) is substantially equal to a first or a second predefined constant within a predefined tolerance margin, e.g. within a predefined tolerance margin of ±10°, or ±6°, or ±2°.

In an embodiment, the first predefined constant may be equal to +90° (or +π/2), and the second predefined constant may be equal to −90° (or −π/2).

An example of this embodiment is illustrated in FIG. 2, where e.g. two sensor signals are measured and temporarily stored in a digital register (or temporarily held by a sample-and-hold circuit in front of the digitizer), and a first angle α is calculated as arctan(signal1/signal2), and a second angle β is calculated as arctan(signal2/signal1), as can be achieved e.g. by swapping the values in the digital registers prior to performing the division, or by rerouting the signals from the sample-and-hold circuit towards the digitizer, or in other suitable manners obtaining the same effect.

In an embodiment, step e) comprises: testing if said sum is substantially equal to +90° in case a sign of the first digital sensor value and a sign of the second digital sensor value are equal; and testing if said sum is substantially equal to −90° in case the sign of the first digital sensor value and the sign of the second digital sensor value are different.

In an embodiment, the angle calculator comprises a divider and an arctangent calculator; and step c) comprises: calculating the first input value (e.g. IN1) by dividing the first digital signal (e.g. s1) by the second digital signal (e.g. s2), and providing the first input value (e.g. IN1) to the arctangent calculator for calculating the first angle value (e.g. α); and the method further comprises a step of testing whether an absolute value of the first input value (e.g. IN1) is smaller than 1.0; and if an outcome of this test is false, skipping steps d) to step f); and if the outcome of this test is true, calculating in step d) the second input value (e.g. IN2) in accordance with the formula IN2=2*IN1/(1−IN1*IN1), and testing in step e) whether the first angle value (e.g. α) is substantially equal to the second angle value (e.g. β) divided by 2.0, e.g. within a tolerance margin of ±10°, or ±6°, or ±2°.

It is an advantage of this embodiment that it not only tests the arctangent function, but also the square function, and the division-function.

In an embodiment, the angle calculator comprises a divider and an arctangent calculator; and step c) comprises: calculating the first input value (e.g. IN1) by dividing the first digital signal (e.g. s1) by the second digital signal (e.g. s2), and providing the first input value (e.g. IN1) to the arctangent calculator for calculating the first angle value (e.g. α); and step d) comprises: calculating the second input value (e.g. IN2) in accordance with the formula IN2=(sqrt(IN1*IN1+1)−1)/IN1, and testing in step e) whether the first angle value (e.g. α) is substantially equal to the second angle value (e.g. β), e.g. within a tolerance margin of ±10°, or ±6°, or ±2°.

In an embodiment, the angle calculator comprises a divider and an arctangent calculator; and step c) comprises: calculating the first input value (e.g. IN1) as N times the first digital signal (e.g. s1), or as N times the second digital signal (e.g. s2), or as N times the first digital signal (e.g. s1) divided by the second digital signal (e.g. s2), and providing the first input value (e.g. IN1) to the arctangent calculator for calculating the first angle value (e.g. α), wherein N is a predefined number (e.g. N=0.5 or N=2.0 or 3.0 or 2.5 or 4.75 or any other number); and wherein step d) comprises: calculating the second input value (e.g. IN2) in accordance with the formula IN2=(sqrt(N*N*IN1*IN1+1)−1)/(N*IN1), and testing in step e) whether the first angle value (e.g. α) is substantially equal to 2.0 times the second angle value (e.g. β), e.g. within a tolerance margin of ±10°, or ±6°, or ±2°.

The method may further comprise steps for calculating the arctangent value of the digitized signal itself, resulting in a third angle gamma, which may also be provided as an output.

In an embodiment, the value of the known number N is 0.5.

In an embodiment, the value of the known number N is 2.

In an embodiment, the value of the known number N is 3.

In an embodiment, the value of N is dynamically varied, e.g. by periodically selecting values from a predefined list.

According to a second aspect, the present invention also provides a method of testing a magnetic position sensor device that comprises an angle calculator and a first group and a second group of magnetic sensors, wherein the first group of magnetic sensors is configured for providing a first set of quadrature signals comprising a first signal and a second signal indicative of orthogonal magnetic field components (e.g. Bx, By) e.g. in-plane components oriented in a first direction (e.g. X) and a second direction (e.g. Y) perpendicular to the first direction, and wherein the second group of magnetic sensors is configured for providing a second set of quadrature signals comprising a third signal and a fourth signal indicative of magnetic field gradients (e.g. dBz/du, dBz/dv) along two perpendicular directions (e.g. U, V) having a predefined angular offset (e.g. w) relative to the first direction (e.g. X) in the range from 5° to 85°, e.g. along a third direction (U) and a fourth direction (V) perpendicular to the third direction (U), wherein the third direction is angularly rotated by said angular offset (w) with respect to the first direction (X); the method comprising the steps of: a) obtaining the first and the second signal from the first group of magnetic sensors; b) amplifying and digitizing the first signal to obtain a first digital signal (e.g. s1), and amplifying and digitizing the second signal to obtain a second digital signal (e.g. s2); c) deriving a first input value or a first set of input values (e.g. IN1) from said first and second digital signal (e.g. s1, s2), and applying this first input value or this first set of input values (e.g. IN1) to the angle calculator, and obtaining a first angle value (e.g. α) from the angle calculator; d) obtaining the third and the fourth signal from the second group of magnetic sensors; c) amplifying and digitizing the third signal to obtain a third digital signal (e.g. s3), and amplifying and digitizing the fourth signal to obtain a fourth digital signal (e.g. s4); f) deriving a second input value or a second set of input values (e.g. IN2) from said third and fourth digital signal (e.g. s3, s4), and applying this second input value or this second set of input values (e.g. IN2) to the angle calculator, and obtaining a second angle value (e.g. β) from the angle calculator; g) performing a consistency test of the first angle value (e.g. α) and the second angle value (e.g. β) based on a predefined mathematical relationship that takes into account said predefined angular offset (e.g. v); h) detecting an error of the magnetic position sensor device based on an outcome of the consistency test.

With “arranged substantially at the centre” is meant at a radial distance smaller than 300 nm from the centre, or smaller than 250 nm, or smaller than 200 nm.

A slightly larger tolerance margin may be required in this embodiment, because the first angle value is insensitive to an external disturbance field, but the second angle is sensitive to an external disturbance field.

This method is particularly useful when implemented in an angular sensor device, mounted in an “on-axis configuration” with respect to a permanent magnet (e.g. a two-pole magnet).

It is noted that some of the steps may be performed outside of the magnetic sensor device, e.g. by an ECU connected to the magnetic sensor device. This ECU may comprise a second angle calculator.

In an embodiment, the first group comprises at least four horizontal Hall elements (e.g. H4-H7) located on a virtual circle having a centre, and wherein the second group comprises at least two magnetic sensor elements (e.g. V1, V2) arranged substantially at the centre of said virtual circle; and wherein the angle calculator comprises a divider and an arctangent calculator; and wherein step c) comprises: calculating the first input value (e.g. IN1) by dividing the first digital signal (e.g. s1) by the second digital signal (e.g. s2), and providing the first input value (e.g. IN1) to the arctangent calculator for calculating the first angle value (e.g. α); and wherein step d) comprises: calculating the second input value (e.g. IN2) by dividing the third digital signal (e.g. s3) by the fourth digital signal (e.g. s4), and providing the second input value (e.g. IN2) to the arctangent calculator for calculating the second angle value (e.g. β); and wherein step g) comprises: testing if the sum of the first angle value (α) and said predefined angular offset (w) is substantially equal to the second angle value (β), e.g. within a tolerance margin of ±10°, or ±6°, or ±2°, or wherein step g) comprises: testing if the sum of the first angle (e.g. α) and the second angle value (e.g. β) is substantially equal to a first or a second predefined constant, e.g. within a tolerance margin of ±10°, or ±6°, or ±2°.

In an embodiment, the method further comprises: outputting the first angle value (e.g. α) by the magnetic sensor device to another processing device (e.g. an ECU).

In an embodiment, the method further comprises: outputting the first angle value (e.g. α) and the second angle (e.g.) by the magnetic sensor device to another processing device (e.g. an ECU).

In an embodiment, the method further comprises: outputting the first angle value (e.g. α) and a diagnostic signal indicative of an error being detected by the magnetic sensor device to another processing device (e.g. an ECU).

In an embodiment, step g) comprises: testing if the sum of the first angle (e.g. α) and the second angle value (e.g. β) minus the predefined angular offset (e.g. w) is substantially equal to +90° or substantially equal to −90°, e.g. within a tolerance margin of ±10°, or ±6°, or ±2°.

In an embodiment, the method further comprising one or more of the following features: i) wherein the second group of sensor elements comprises two vertical Hall elements oriented with their axis of maximum sensitivity in orthogonal directions (e.g. in the X direction and the y direction); ii) wherein the first group of sensor elements comprises four horizontal Hall elements arranged near an edge of an integrated magnetic concentrator (IMC), angularly spaced apart by multiples of 90°; iii) wherein the first group of sensor elements comprises four horizontal Hall elements arranged on the virtual circle, and spaced apart by multiples of 90°, e.g. as illustrated in FIG. 13A; iv) wherein the predefined angular offset (w) is equal to 0° or is equal to 90° or is equal to 45°.

In an embodiment, the second group of sensor elements comprises two pairs of two vertical Hall elements. The axes of maximum sensitivity of vertical Hall elements within each pair being oriented in parallel (and preferably coinciding). The axes of maximum sensitivity of vertical Hall elements from different pairs being perpendicular to each other. As an example, the second group of sensor elements may comprise two vertical elements arranged near the sides of a virtual square located at the centre of said virtual circle. By adding or averaging the signals of a pair, the signal amplitude can be increased and/or the signal-to-noise ratio (SNR) can be improved.

In an embodiment, the second group of sensor elements comprises four pairs of two horizontal Hall elements, the pairs being arranged near an edge of the circular integrated magnetic concentrator, the pairs are angularly spaced apart by multiples of 90°, the horizontal Hall elements within each pair are arranged adjacent each other in a circumferential direction, e.g. as illustrated in FIG. 13A. By adding or averaging the signals of a pair, the signal amplitude can be increased and/or the signal-to-noise ratio (SNR) can be improved.

In an embodiment, the first group of sensor elements comprises four pairs of two horizontal Hall elements, the pairs being arranged on the virtual circle, the pairs being angularly spaced apart by multiples of 90°, the horizontal Hall elements within each pair being arranged adjacent each other in a circumferential direction, e.g. as illustrated in FIG. 9A. By adding or averaging the signals of a pair, the signal amplitude can be increased and/or the signal-to-noise ratio (SNR) can be improved.

It is explicitly pointed out that each of the four examples of the second group of sensors described above (horizontal Hall elements with IMC or vertical Hall elements without IMC, in pairs or individual) can be combined with each of the two examples of the first group of sensors described above (four horizontal Hall elements, or eight horizontal Hall elements), thus resulting in eight possible combinations, only two of which are shown in FIG. 9A and FIG. 9B.

According to a third aspect, the present invention also provides a magnetic sensor device comprising: a single angle calculator; at least two magnetic sensor elements; a processing circuit configured for performing a method according to the first aspect.

In an embodiment, the magnetic sensor device further comprises said first and second data register.

According to a fourth aspect, the present invention also provides a magnetic sensor device comprising: an angle calculator; at least two groups of magnetic sensor elements; a processing circuit configured for performing a method according to the second aspect.

The sensor elements of a sensor device according to the third or fourth aspect may be selected from the group consisting of: magnetic sensor elements, horizontal Hall elements, vertical Hall elements, magneto-resistive elements (e.g. GMR, XMR, AMR), magneto-impedance elements (e.g. GMI), optical sensor elements, a MEMs element, an accelerometer sensor.

The sensor device according to the third or fourth aspect may be an angular or a linear position sensor device, a tilt sensor, etc.

According to a fifth aspect, the present invention also provides a magnetic position sensor system comprising: a magnetic sensor device according to the third aspect or according to the fourth aspect; and a permanent magnet movably mounted relative to the sensor device.

In an embodiment, the magnetic position sensor system further comprises a second processor, e.g. in the form of an electronic control unit (e.g. ECU), and the magnetic sensor device is configured for providing at least the first angle (e.g. α) to the second processor, and optionally also one or more of the following: the error signal, the second angle (e.g. β), the second input value or the second set of input values (e.g. IN2), a ratio of the second input values.

In an embodiment, the ECU also has an angle calculator, and is configured for receiving the second input value or the second set of input values (e.g. Bx and By of FIG. 14, or the ratio Bx/By as a single value, or the ratio of By/Bx; or the values dBz/du and dBz/dv of FIG. 14, or the ratio (dBz/du)/(dBz/dv), or the ratio (dBz/dv)/(dBz/du)), and is further configured for determining the second angle β, and for performing the consistency test.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows a high-level block diagram of a known magnetic sensor device comprising a divider and an angle calculator, but without self-diagnostics.

FIG. 2 shows a high-level block diagram of an illustrative example of a sensor device according to an embodiment of the present invention.

FIG. 3 shows a high-level block diagram of another illustrative example of a sensor device according to an embodiment of the present invention.

FIG. 4 shows a high-level block diagram of yet another illustrative example of a sensor device according to an embodiment of the present invention.

FIG. 5 to FIG. 8 shows examples of timing-diagrams that may be used in embodiments of the present invention.

FIG. 9 shows an example of a magnetic sensor system according to an embodiment of the present invention.

FIG. 10 shows another example of a magnetic sensor system according to an embodiment of the present invention.

FIG. 11A shows an illustrative example of a sine and a cosine waveform as a function of angular displacement, as may be measured by the sensors of the sensor device of FIG. 9.

FIG. 11B shows that the sum of arctangent(Bx/By) and arctangent(By/Bx) is substantially equal to a first constant (+π/2) or a second constant (−π/2), if the arctangent function returns a value in the range from −π/2 to +π/2.

FIG. 12 shows a variant of FIG. 11B, in case the arctangent function returns a value in the range from 0 to π.

FIG. 13A shows an example of another magnetic sensor system according to an embodiment of the present invention, wherein the sensor device comprises a first group of magnetic sensor elements located on a virtual circle, and a second group of magnetic sensor elements located at the centre of the circle.

FIG. 13B shows a sensor arrangement that may be used in the sensor device of FIG. 13A.

FIG. 14 shows a variant of FIG. 13A, using a first group of four pairs of horizontal Hall elements arranged on the circle, and using a second group of four pairs of horizontal Hall elements arranged near an integrated flux concentrator (IMC) located at the centre of the circle.

FIG. 15A shows an example of waveforms as may be measured by the sensor elements of FIG. 13A or FIG. 14 or derived therefrom.

FIG. 15B shows that the sum of arctangent(Bx/By) and arctangent[(dBz/dv),(dBz/vu)] is substantially equal to a first constant or a second constant.

FIG. 16 shows a variant of FIG. 15B, in case the arctangent function returns a value in the range from −π to +π.

FIG. 17 to FIG. 20 are flow-charts of methods according to embodiments of the present invention.

The drawings are only schematic and are non-limiting. In the drawings, the size of some of the elements may be exaggerated and not drawn on scale for illustrative purposes. Any reference signs in the claims shall not be construed as limiting the scope. In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In this document, unless explicitly mentioned otherwise, the term “sensor device” refers to a semiconductor device, packaged or unpackaged, comprising at least one “sensor element”. The sensor device may be comprised in a package, also called “chip”, although that is not absolutely required. The sensor device preferably contains a semiconductor substrate.

In this document, the term “magnetic sensor element” or “magnetic sensor” can refer to a component or a group of components or a sub-circuit or a structure capable of measuring a magnetic quantity, such as for example a magneto-resistive (MR) element, a GMR element, an XMR element, a horizontal Hall plate, a vertical Hall plate, a Wheatstone-bridge containing at least one (but preferably four) magneto-resistive elements, etc. or combinations hereof.

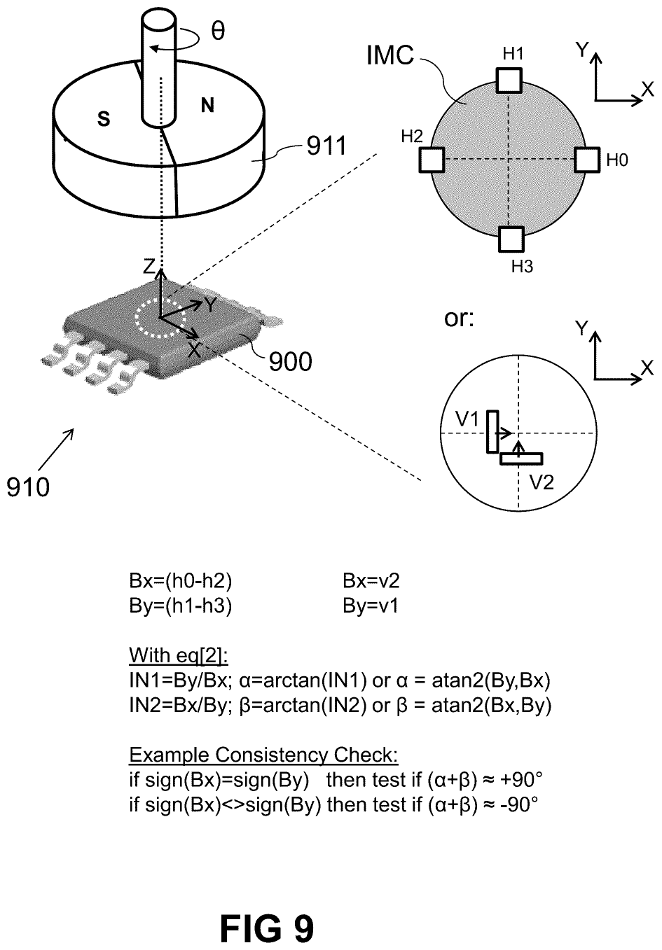

In certain embodiments of the present invention, the term “magnetic sensor” or “magnetic sensor structure” may refer to an arrangement comprising one or more integrated magnetic concentrators (IMC), also known as integrated flux concentrators, and one or more horizontal Hall elements arranged near the periphery of the IMC, for example a disk shaped IMC with two horizontal Hall elements 180° spaced apart from each other (not shown), or an IMC with four horizontal Hall elements spaced apart by multiples of 90° (e.g. as shown in FIG. 9).

In this document, the expression “in-plane component of a magnetic field vector” and “projection of the magnetic field vector in the sensor plane” mean the same. If the sensor device comprises a substrate, this also means “magnetic field component parallel to the substrate”. In-plane components are typically referred to as Bx and By.

In this document, the expression “out-of-plane component of a vector” and “Z component of the vector” and “projection of the vector on an axis perpendicular to the sensor plane” mean the same. This component is typically referred to as Bz.

In this document, the word “magnet”, “magnetic structure” and “magnetic source” are used as synonyms.

Embodiments of the present invention are typically described using an orthogonal coordinate system which is fixed to the sensor device, and having three axes X, Y, Z, where the X and Y axis are parallel to the substrate, and the Z-axis is perpendicular to the substrate.

In this document, the expression “spatial derivative” or “derivative” or “spatial gradient” or “gradient” are used as synonyms. In the context of the present invention, a gradient of a certain component (e.g. By) “along the X-direction” is typically determined as a difference (e.g. ΔBy) between two such component values (e.g. By1, By2) measured at two locations spaced apart in the X-direction. In theory the gradient (e.g. dBy/dx) is calculated as the difference (e.g. ΔBy) between two values divided by the distance “dx” between the sensor locations, but in practice the division by “dx” is often omitted, because the measured signals need to be scaled anyway. Hence, in the context of the present invention, the magnetic field difference (e.g. ΔBy) and the magnetic field gradient (e.g. dBy/dx) are used interchangeably.

In this application, horizontal Hall plates are typically referred to by H1, H2, etc.; signals from horizontal Hall plates are typically referred to by h1, h2, etc.; vertical Hall plates are typically referred to by V1, V2, etc.; and signals from vertical Hall plates are typically referred to by v1, v2, etc.

In the context of the present invention, the functions arctan( ) and a tan 2( ) are both referred to as “arctangent function”. The first function arctan(R) receives a single argument (e.g. R). The single argument R may be a ratio of two values x/y, but that is not absolutely required. In this case, the division operation is performed outside of the arctan function. The second function a tan 2(x,y) receives two arguments, and a division is implicitly performed inside the a tan 2 function.

The present invention is related to sensor devices having self-diagnostics or self-test capabilities, and more in particular to magnetic sensor devices having a single “angle calculator” (e.g. hardware circuit or software module) and having capabilities to detect an error of that angle calculator. The present invention is also related to methods of testing such a sensor device, in particular the angle calculator thereof, by the sensor device itself.

As mentioned in the background section, a classical approach to test if a particular function of a sensor device is still functioning properly, is to provide two identical signal paths, route the same input signals to both signal paths, and compare the outputs. A disadvantage of this approach is that it requires duplicating the actual function, which typically requires a larger circuit (e.g. larger chip area).

Another classical approach is to store a limited number of predefined input values, and corresponding known good output values, and to apply one of these predefined input values to the function (e.g. circuit block or software module) to be tested, and test if the actual output value corresponds with the expected predefined output value. This approach has as main disadvantage that the number of predefined input and output values is limited and requires extra storage space (e.g. in flash). Another disadvantage is that performing the test may interrupt the normal output stream of periodic measurements.

The inventors of the present invention came to the idea of testing the angle calculator in a different way, namely:
by operating a single angle calculator twice: a first time with a first input value (or set of input values) IN1 resulting in a first angular output (e.g. α), and a second time with a second input value (or a second set of input values) IN2 resulting in a second angular output (e.g. β);
wherein the first input value (or set of input values) IN1 is/are not predefined values, but is/are derived from the sensor signal(s), and thus are typically varying over time;
and wherein the second input value(s) IN2 have a first predefined (e.g. mathematical and/or geometrical) relationship with the first input value(s) IN1, chosen such that the output values also have a second predefined (e.g. mathematical and/or geometrical) relationship (if everything is working correctly);
and by detecting an error if the calculated first and second angular value do not satisfy the second predefined relationship.

In preferred embodiments, the sensor device has at least two magnetic sensors configured to provide quadrature signals, e.g. individually or in combination, and the signals obtained from these sensors are amplified (and preferably also sensitivity-corrected in manners known in the art), and digitized, and the digital values are temporarily stored in two (or more) data-registers, and a first set of input values (or a single first input value, a first ratio of two amplified and digitized sensor signals) for calculating the first angle α is retrieved or derived from the values stored in these data-registers, and a second set of input values (or a second input value, a second ratio of two amplified and digitized sensor signals) for calculating the second angle β is retrieved or derived from the same values stored in said data-registers, before a new data acquisition occurs. This offers the advantage that the first angle α and the second angle β are derived from the same numerical values that were stored in the data registers. This offers the advantage that the first angle α and the second angle β are highly consistent, even for a fast changing magnetic field (e.g. induced by a magnet rotating at high speed).

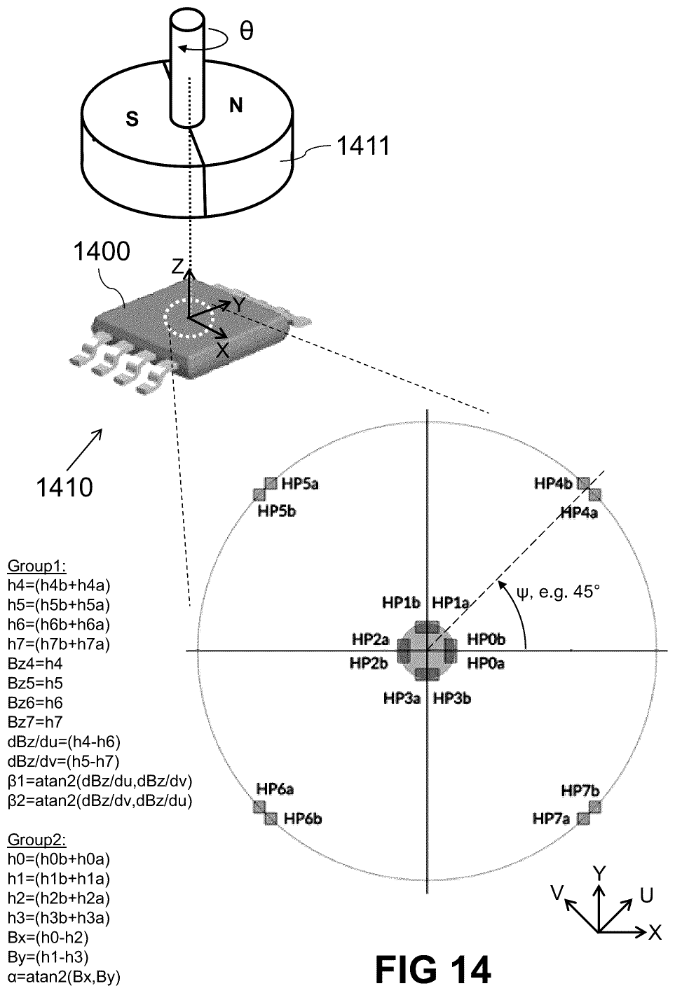

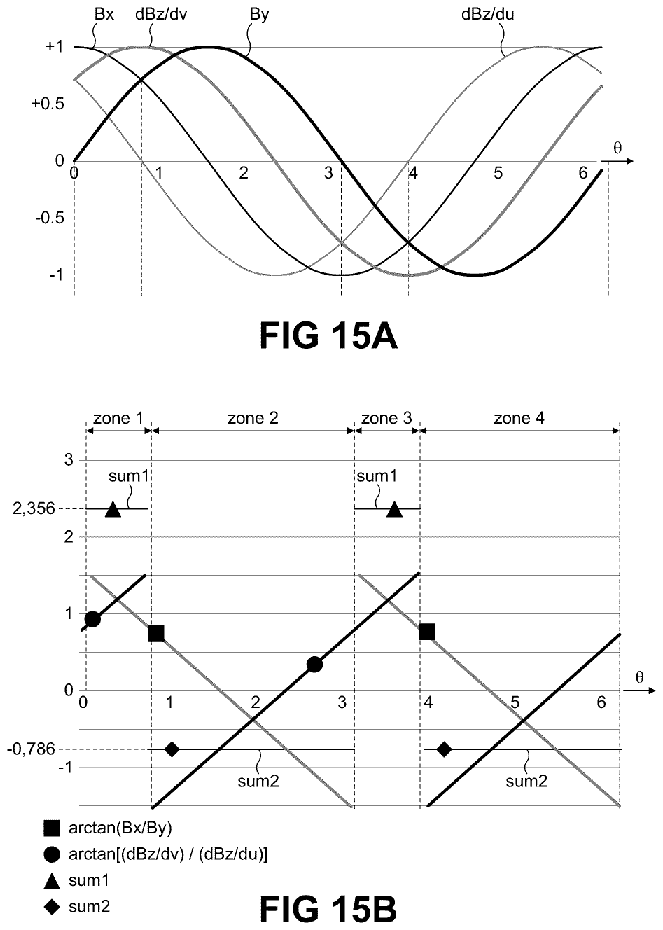

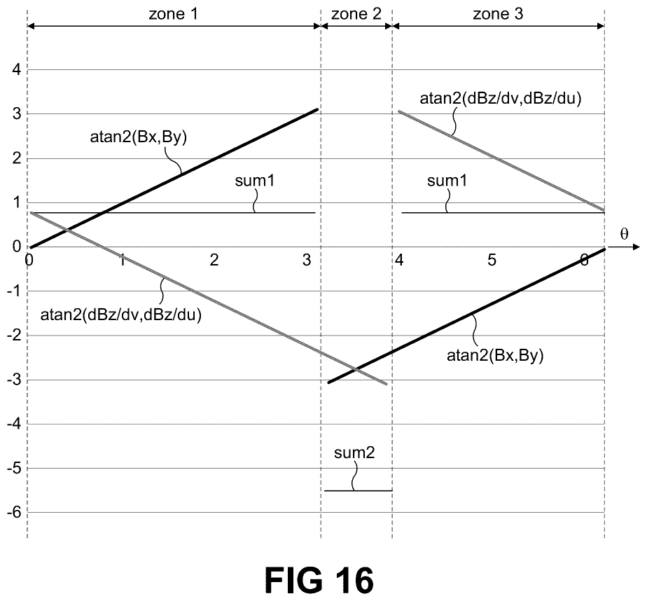

In other preferred embodiments (e.g. illustrated in FIG. 13A, FIG. 13B, FIG. 14), the sensor device has at least two groups of magnetic sensors, each group configured for providing quadrature signals, e.g. individually or in combination. The first angle α may be derived from the first set of quadrature signals, the second angle β may be derived from the second set of quadrature signals. A mathematical relationship between the first angle α and the second angle β may be defined by the geometric positions and/or orientations of the sensor elements.

When signals from various sensor elements are to be combined (e.g. added or subtracted), such combinations are preferably performed in the analog domain, before amplification.

These are the main principles underlying the present invention.

Referring now to the Figures.

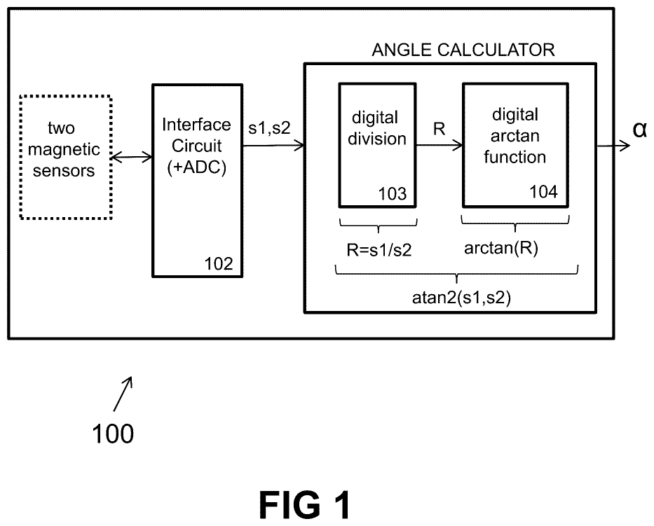

FIG. 1 shows a high-level block diagram of a magnetic sensor device 100, known in the art. The sensor device 100 comprises two magnetic sensors; an interface circuit 102 comprising a “biasing and readout circuit” and an analog-to-digital convertor (ADC); a digital divider 103 for performing a digital division operation on the digitized sensor signals and for providing a ratio R, and a circuit 104 for determining an arctangent function of the ratio R. The sensor device 100 of FIG. 1 does not have a self-diagnostic function.

In fact, two “arctangent functions” are known in the art: a “single-argument” arctangent function written as arctan(R), and a two-argument arctangent function written as a tan 2(s1,s2) or as arctan 2(s1,s2). As illustrated, the “two-argument arctangent” function can be considered as a combination of a digital division function and a “single-argument arctangent” function.

When in the present invention the term “angle calculator” is used with a single argument, it usually refers to the single-argument arctangent function (excluding the division), unless it is clear from the context that something else was meant. When in the present invention the term “angle calculator” is used with two arguments, it usually refers to the two-argument arctangent function (including the division) unless it is clear from the context that something else was meant. When the term “angle calculator” is used without explicitly mentioning one or two arguments, either the single-argument arctangent function and the two-argument arctangent function is referred to. In a practical implementation, the “angle calculator” typically also tests whether the envisioned denominator s2 is different from zero, before performing the division, and may add or subtract multiples of 180° (or π radians) from the output of the arctan function block 104, depending on the sign of the two arguments s1, s2, but such aspects are implementation details which are well known in the art. Relevant for the present invention is that the “angle calculator” of FIG. 1 comprises a digital arctan function 104 and also a digital divider 103.

The functional blocks 103 and 104 can be implemented fully in hardware, e.g. as two dedicated hardware blocks, or can be implemented in software modules running on a digital processor, e.g. a simple microcontroller (CPU) or a digital signal processor (DSP). The arctan function may for example be implemented by means of a look-up table stored in a non-volatile memory (e.g. flash memory) with or without linear interpolation. The function blocks shown in FIG. 1 should therefore not be interpreted as hardware circuit but may also be fully or partially be implemented as “software modules” or “software routines”.

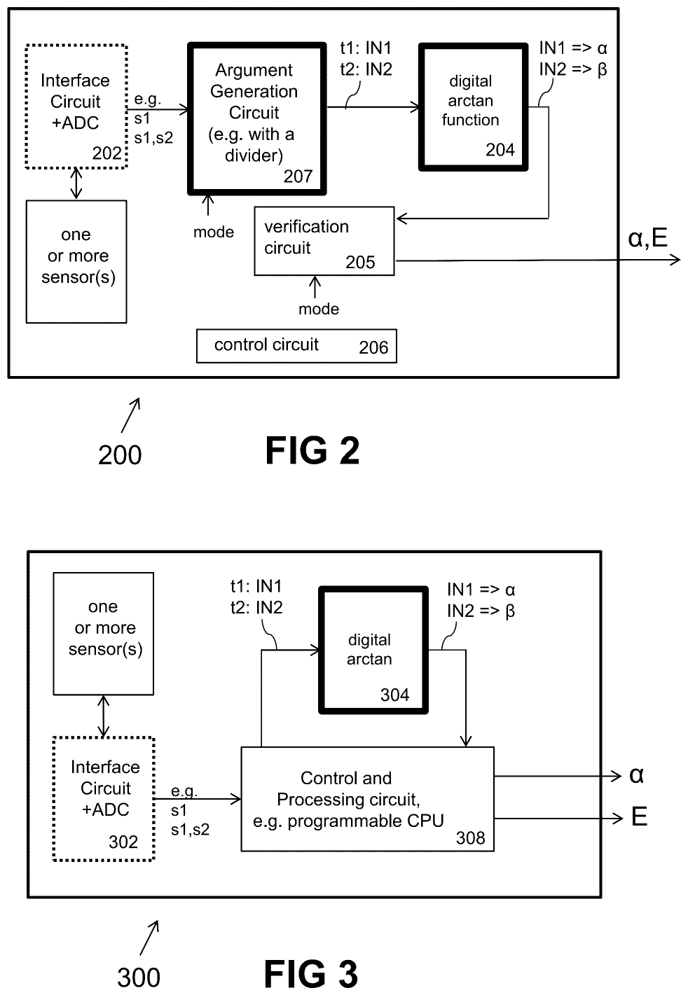

FIG. 2 shows a high-level block diagram of an illustrative example of a sensor device 200. This sensor device 200 comprises one or more sensors, e.g. at least two sensors, e.g. selected from the group consisting of magnetic sensors, micro-electromechanical (MEMs) sensors, accelerometer sensors, gyroscopic sensors, for example two sensors oriented in orthogonal directions for determining a direction of a magnetic field, or a direction of force, or a direction of acceleration. The sensor device 200 further comprises an interface circuit 202 with an analog-to-digital convertor ADC. Depending on the type of sensor(s), the interface circuit 202 may comprise for example a “biasing and readout circuit” or only a readout circuit, e.g. a Wheatstone bridge. The interface circuit 202 provides one or more digital signals, e.g. only s1, or s1, s2, derived from one or more sensor signals, e.g. by amplification and digitization. The sensor device 200 further comprises a functional block 204 (e.g. hardware circuit or software routine) for determining an arctangent function, which may be identical to the circuit 104 of FIG. 1, or to the angle calculator of FIG. 1, or may be different.

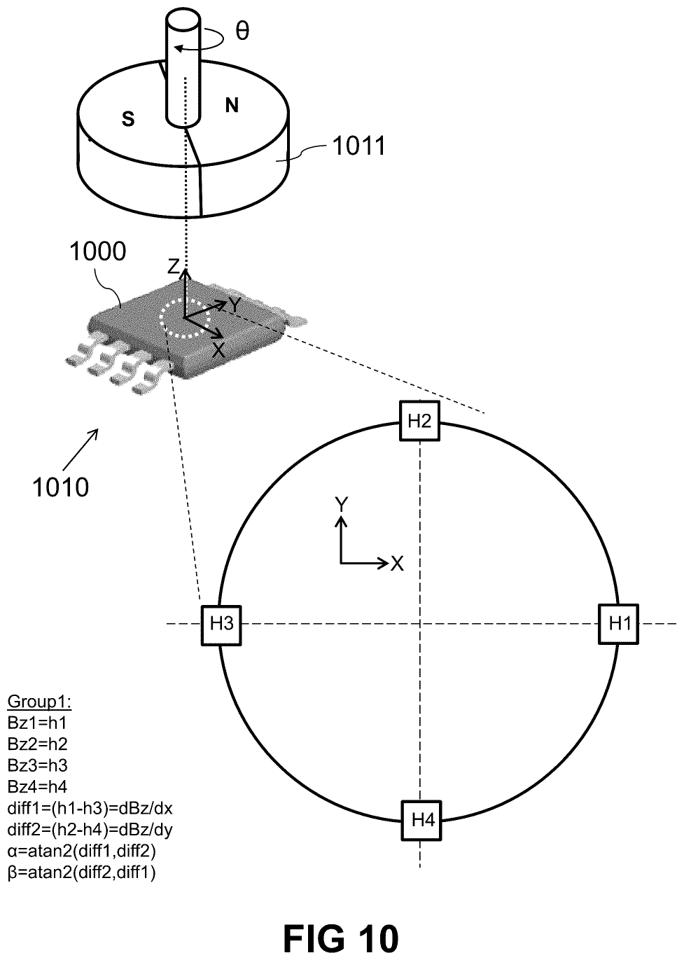

According to an underlying principle of the present invention, however, the arctangent function block 204 is provided with a first input IN1 (e.g. a single digital value or a set of two digital values) at a first moment in time t1, yielding a first angle value α, and is provided with a second input IN2 (e.g. a single digital value or a set of two digital values) at a second moment in time t2, yielding a second angle value β. Both the first input IN1 and the second input IN2 are derived from the sensor signals. They may be based on the same numerical values derived from the same sensor signals (see e.g. FIG. 9, FIG. 10), e.g. captured at a particular moment in time, and temporarily stored in data registers, or based on two different sets of numerical values obtained from different sensor signals (see e.g. FIG. 13A, FIG. 14).

The value or the set of values IN1 and IN2 are typically different from each other, apart from exceptions, but they have a predefined first relationship, e.g. a first mathematical relationship in accordance with a first predefined function involving IN1 and IN2. This relationship may be imposed by a control circuit 206, in manners known in the art, e.g. using a programmable microcontroller or a finite state machine, etc. The sensor device 200 further comprises a verification block 205 configured for receiving the first and the second angle value α, β and for testing if they are consistent, by testing if they satisfy a predefined second relationship, e.g. a second mathematical relationship in accordance with a second predefined function involving a and β.

As an example, assume that the interface circuit 202 provides two digital signals s1 and s2, and that the first input IN1 is calculated as s1/s2, and that the second input IN2 is calculated as s2/s1. This results in a first angle α=arctan(s1/s2) and a second angle β=arctan(s2/s1), wherein the arctan function is calculated by a single functional block 204 operated twice. By testing the second relationship between α and β, in this case, by testing whether the sum of α and β is substantially equal to one of two predefined constants, apart from rounding errors, a fault can be detected. In hindsight, the skilled reader may recognize that this example is built on the following mathematical formula:

$$arctan ( x ) + arctan ( 1 / x ) = 90 ° , if x > 0 \qquad [ 1 a ]$$

$$arctan ( x ) + arctan ( 1 / x ) = - 90 ° , if x < 0 \qquad [ 1 b ]$$

but the present invention is not directed to these mathematical formulas per se, nor is it limited to this particular mathematical formula, and solutions based on other mathematical identity formulas can also be used, such as for example:

$$arctan ( s 1 / s 2 ) + arctan ( s 2 / s 1 ) = 90 ° , if s 1 and s 2 have a same sign \qquad [ 2 a ]$$

$$arctan ( s 1 / s 2 ) + arctan ( s 2 / s 1 ) = - 90 ° , if s 1 and s 2 have opposite sign \qquad [ 2 b ]$$

$$or : arctan ( x ) = \frac{1}{2} arctan ( \frac{2 x}{1 - {x}^{2}} ) , for values - 1 < x < + 1 ; \qquad [ 3 ]$$

$$or arctan ( x ) = 2 arctan ( \frac{\sqrt{{x}^{2} + 1} - 1}{x} ) , for values x <> 0 ; \qquad [ 4 ]$$

$$or arctan ( 2 x ) = 2 arctan ( \frac{\sqrt{4 {x}^{2} + 1} - 1}{2 x} ) , for values x <> 0 ; \qquad [ 5 ]$$

$$or arctan ( Nx ) = 2 arctan ( \frac{\sqrt{{N}^{2} {x}^{2} + 1} - 1}{Nx} ) , for values x <> 0 ; \qquad [ 6 ]$$

where N is a predefined real number, for example N=2, or N=2.5, or N=3, or N=0.5, or N=0.25, or any other suitable number different from zero, and where the value of x is derived from one or more of the sensor signals, for example x=(s1/s2) in combination with [3] or [4], or for example x=s1/(2*s2) in combination with [5], or for example x=s1/(N*s2) in combination with [6],

$$or arctan ( x / y ) = \{ \begin{matrix}2 arctan ( \frac{y}{\sqrt{{x}^{2} + {y}^{2}} + x} ) & if x > 0 , \\ 2 arctan ( \frac{\sqrt{{x}^{2} + {y}^{2}} - x}{y} ) & if x \leq 0 and y \neq 0 , \\ π & if x < 0 and y = 0 , \\ undefined & if x = 0 and y = 0.\end{matrix} \qquad [ 7 ]$$

As can be seen, the formulas [1] to [3] require a division and an arctangent, but not a square function or a square root function. These are simpler to implement and require a less powerful processing circuit and/processor. The formulas [4] to [7] require a division, and an arctangent, and a square function, and a square root function, and thus are more complex.

On the other hand, an implementation based on the formulas [4] to [7] is not only capable to detect an error in the division function and the arctangent function but is furthermore capable to detect an error in the square function and the square root function. An implementation based on the formulas [4] to [7] may therefore be preferred in sensor devices where a norm (sum of squares) of the sensor signals is also required.

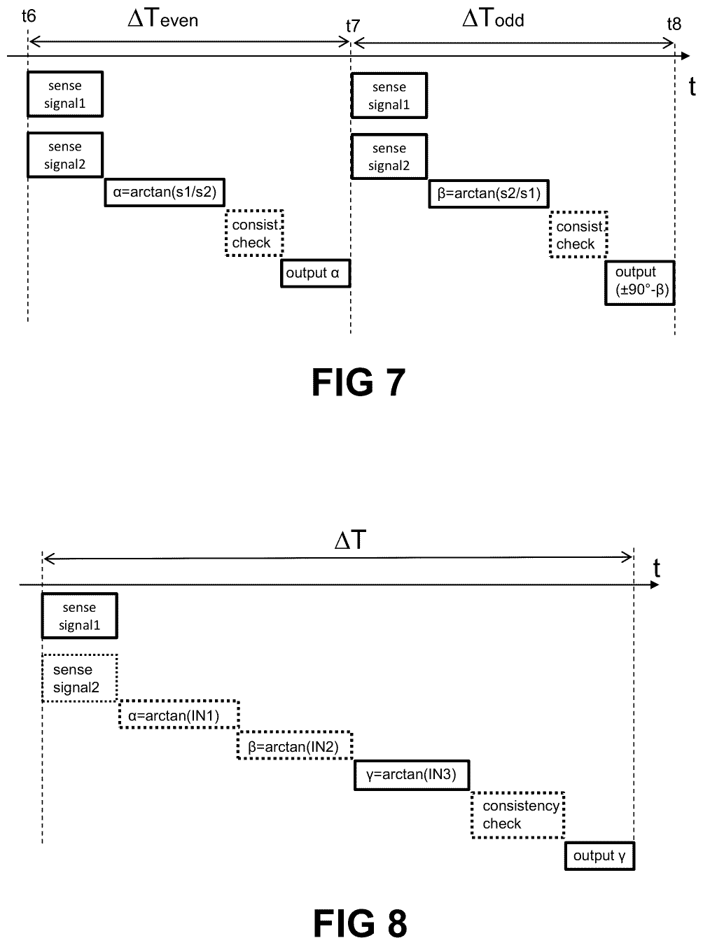

In many applications, it is not required to diagnose the circuit for each new sensor signal obtained from the one or more sensor(s), but it suffices to test the circuit once in a while, or only for certain values but not for other values. This will be discussed further in FIG. 5 to FIG. 8.

In the sensor device of FIG. 2, the verification is performed inside the sensor device 200 itself, and the sensor device will typically output the first angle α, and a diagnostic signal E (e.g. error signal) for indicating that an error has been detected.

In a variant, the verification of the consistency between the angles α and β is not only performed by the device itself, but is also performed outside of the sensor device, e.g. in an electronic control unit (ECU) connected to the sensor device. In this case, the sensor device 200 would output the two angle values α and β to the external control unit (not shown), e.g. via a communication bus, and the external control unit may or would also verify whether the two angle values α and β satisfy the second predefined relationship.

The block diagram of FIG. 2 is only a schematic representation of the various functions of the sensor device 200 but does not necessarily represent a circuit block diagram. Indeed, other circuit topologies for performing the same functions can also be used, and some or all of these functions may be performed in software, for example as will be described next.

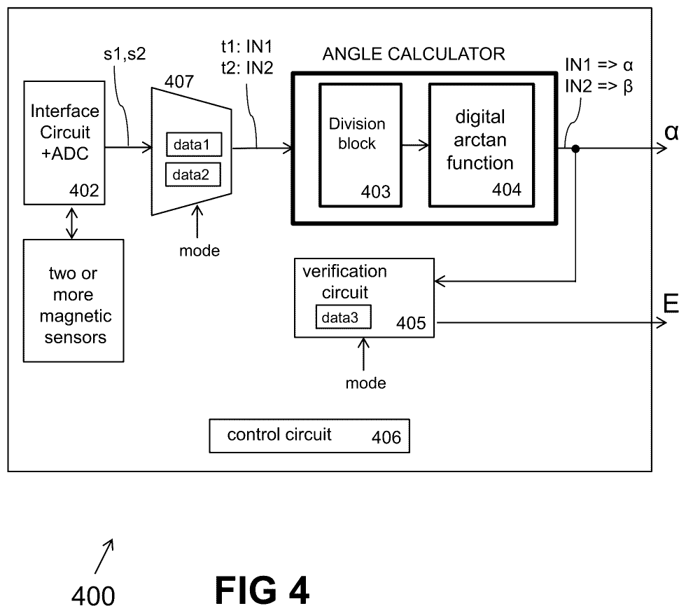

FIG. 3 shows a high-level block diagram of another sensor device 300, which can be seen as a variant or a special case of the sensor device 200 of FIG. 2. The device 300 has one or more sensors, e.g. at least two magnetic sensors, and an interface circuit 302 comprising at least one analog-to-digital convertor (ADC), and has a dedicated arctangent block 304 (e.g. implemented in hardware or in software, or partially in hardware and partially in software, e.g. by means of a look-up table with linear interpolation), and wherein most of the other functions (e.g. the generation of the input signals IN1, IN2) are performed by a programmable processor, e.g. by a microcontroller (CPU) or by a digital signal processor (DSP). Everything else described above for FIG. 2 is also applicable here. For example, the consistency check may be performed inside the sensor device 300, in which case the sensor device would output the first angle α and the diagnostics signal E, and optionally but not necessarily the second angle value β. Optionally, the consistency check may also be performed outside the sensor device 300, e.g. by an external processor, e.g. an electronic control unit (ECU) communicatively connected to the sensor device 300, in which case the sensor device 300 would output at least the two angle values α and β. In the latter case, the external processor (not shown) would receive the values α and β and would perform the consistency check. Of course, it is also possible to perform the consistency check both inside and outside of the sensor device 300. This is also true for the sensor device of FIG. 2. As mentioned above, it is not required to perform the consistency check for each measured sample, although it may.

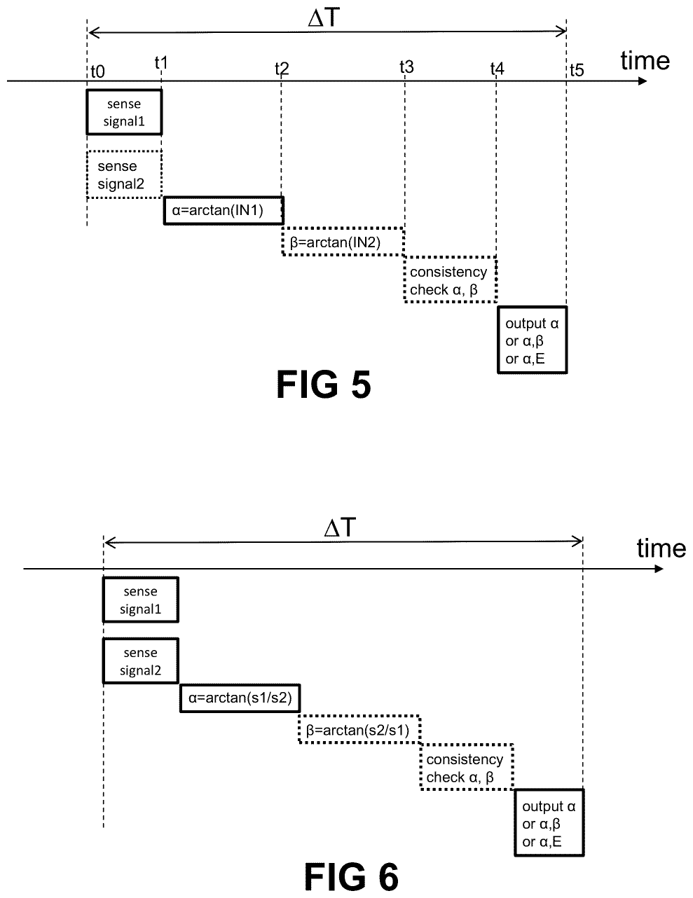

FIG. 4 shows a high level block diagram of yet another illustrative example of a sensor device 400, which can be seen as a variant or a special case of the sensor device 200 of FIG. 2, and which is based on the mathematical equations [2a], [2b] mentioned above.

More specifically, the sensor device 400 comprises at least two sensors, e.g. two magnetic sensors, or two pairs of magnetic sensors, or two groups of magnetic sensors, configured or arranged for providing two quadrature signals (i.e. sinusoidal signals having substantially the same amplitude and being substantially 90° phase shifted). The sensor signals are obtained by the interface circuit 402, e.g. in case of magnetic sensors typically referred to as a “biasing and readout circuit” and are digitized by one or more analog-to-digital convertors ADC. In practice, the signals may also be amplified, etc. but such aspects are well known in the art and are not the main focus of the present invention.

Important for the embodiment of FIG. 4 is that the interface circuit 402 provides at least one pair of two digital signals s1, s2 (for example a sine value and a cosine value) to the “argument generation circuit” 407, which in the example of FIG. 4 could be a very simple block comprising two data-registers data1, data2 and means for swapping the content of these data registers in the digital domain. At a first moment in time t1, the “angle calculator” is provided with a first set of input signals IN1 for calculating a tan 2(sine,cosine) which results in a first angle value α, which angle value is stored in a third data register data3 in the verification circuit 405. Then the contents of the data registers data1 and data2 are swapped or rerouted in a crossed manner such that, at time t2, the “angle calculator” is provided with a second set of input signals IN2 for calculating a tan 2(cosine,sine) which results in a second angle value β, which value is also provided to the verification circuit 405, where a sum of the two angle values α and β is determined, and where it is verified whether the sum is substantially equal to a first predefined constant or is substantially equal to a second predefined constant, taking into account some margin for rounding errors. The first constant may be equal to +90° or +π/2 (rad), the second constant may be equal to −90° or −π/2 (rad), depending on the implementation in degrees or radians. If it is detected that the sum (α+β) deviates more than an allowed tolerance margin, the verification circuit 405 has detected an error, which can then be output by means of a diagnostic signal or an error signal E.

This embodiment can be described in a compact manner as follows:

$$\{ \begin{matrix}α = arctan ( s 1 / s 2 ) \\ β = arctan ( s 2 / s 1 ) \\ Test if ( α + β ) \approx + 90 ° or ( α + β ) \approx - 90 °\end{matrix}$$

where ‘≈’ means: is approximately equal to, within a predefined tolerance margin.

If an “absolute value function” is available, this embodiment can also be described as follows:

$$\{ \begin{matrix}α = arctan ( s 1 / s 2 ) \\ β = arctan ( s 2 / s 1 ) \\ Test if abs ( α + β ) \approx + 90 °\end{matrix}$$

where abs( ) is the absolute value function.

The waveforms of FIG. 10A and FIG. 10B illustrate this in a graphical manner.

It is a major advantage of this technique that it requires only minimal additional hardware and/or software, and that it can be applied in a sensor device having only one angle calculator. It is also a major advantage that the input signals are derived from sensor signals, and are not merely predefined values with a predefined result. In this way, the reliability may be increased, for example because the probability of finding an error somewhere in a look-up table is increased.

Many variants of this embodiment are possible, for example:
i) instead of having an ADC in the interface circuit, and two data-registers data1, data2, and means for swapping or rerouting their contents, it is also possible to obtain the same functionality using two “sample-and-hold” circuits in front of the ADC, and by routing at a first moment in time the two signals in a first manner to the angle calculator, and by routing at a second moment in time the two signals in a crossed manner to the angle calculator.
ii) instead of actually adding the two angles α and β, and testing whether the sum is substantially equal to constant1 or constant2, it is (of course) also possible to calculate a third value value3 equal to (β−constant1), and to calculate a fourth value value4 equal to (β−constant2), and to test whether the first angle α is substantially equal to the third value value3 or substantially equal to the fourth value value4, within a predefined tolerance margin, e.g. within a tolerance margin of ±5°, or ±3°, or ±1°.
iii) a more stringent verification test could be the following: in case the sign of the two digital values obtained from the interface circuit are the same (i.e. both positive or both negative), test if (α+β)≈+90°; and in case the sign of the two digital values obtained from the interface circuit are opposite (i.e. one positive and the other negative), test if (α+β)≈−90°.
iv) another way of testing iii) is the following: determine a fifth value value5 equal to sign(s1)*sign(s2)*90°, where sign( ) is the sign function, which returns the value of +1 for positive arguments, and −1 for negative arguments; then test if (α+β)≈value5.
v) yet another way of testing iii) is the following: determine a fifth value value5 equal to sign(s1*s2)*90°, where sign( ) is the sign function, which returns the value of +1 for positive arguments, and −1 for negative arguments; then test if (α+β)≈value5.
   Example with Eq[3] and Only One Sensor:

From the above, it can be understood that “a diagnostic test based on equation [3]”, and using a sensor device as illustrated in FIG. 2 or FIG. 3 having only a single sensor, may comprise the following steps:
i) measure a physical quantity using the single sensor;
ii) digitize the sensor signal, and call this signal x;
iii) at time t1, apply the signal x as a first input value IN1 to the digital arctan function, yielding a first angle α=arctan(IN1);
   if the absolute value of (x) is ≥1.0, skip the diagnostic test;
   if the absolute value of (x) is <1.0, perform the following steps:
      iv) calculate a second input value IN2 equal to (2x)/(1−x²);
      v) at time t2, provide the second input value IN2 to the digital arctan function, yielding a second angle β=arctan(IN2);
      vi) test if α˜β/2, and if the outcome of this test is false, an error is detected

It is noted that the first angular value α and the second angular value β may not have a physical meaning if the single sensor is for example a temperature sensor, and the value x is for example a normalized value of x (e.g. divided by a predefined upper limit), but it may still be very useful to detect an error of the single-argument arctangent function using such a single sensor value, which varies over time.

Example with Eq[3] and Two Sensors:

A diagnostic test based on equation [3], and using a sensor device as illustrated in FIG. 2 or FIG. 3 and having two sensors, may comprise the following steps:
i) measure two physical quantities using the two sensor;
ii) digitize the sensor signals, and call them s1, s2;
iii) calculate a value x equal to s1/s2;
   if the absolute value of (x) is ≥1.0, skip the diagnostic test;
   if the absolute value of (x) is <1.0, perform the following steps:
      iv) calculate a second input value IN2 equal to (2x)/(1−x²);
      v) at time t2, provide the second input value IN2 to the digital arctan function, yielding a second angle β=arctan(IN2);
      vi) test if α≈β/2, and if the outcome of this test is false, an error is detected.

In a variant, if it is found (in step iii) that (x)>1, then x is calculated as s2/s1 instead, and steps iv) to vi) are performed with the latter value of x, and if it is found that (x)=1, then the diagnostic test is skipped.

Example with Eq[4] and Only One Sensor:

A diagnostic test based on equation [4], and using a sensor device as illustrated in FIG. 2 or FIG. 3 and having only one sensors, may comprise the following steps:
i) measure a physical quantity using the single sensor;
ii) digitize the sensor signal, and call this signal x;
iii) at time t1, apply the signal x as a first input value IN1 to the digital arctan function, yielding a first angle α=arctan(IN1);
iv) calculate a second input value IN2 equal to

$$IN 2 = ( \frac{\sqrt{{x}^{2} + 1} - 1}{x} )$$

v) at time t2, provide the second input value IN2 to the digital arctan function, yielding a second angle β=arctan(IN2);
vi) test if α≈2*β, and if the outcome of this test is false, an error is detected
   Example with Eq[4] and Two Sensors:

A diagnostic test based on equation [4], and using a sensor device as illustrated in FIG. 2 or FIG. 3 and having two sensors, may comprise the following steps:
i) measure two physical quantities using the two sensor;
ii) digitize the sensor signals, and call them s1, s2;
iii) calculate a value x equal to s1/s2;
iv) at time t1, apply the signal x as a first input value IN1 to the digital arctan function, yielding a first angle α=arctan(IN1);
v) calculate a second input value IN2 equal to

$$IN 2 = ( \frac{\sqrt{{x}^{2} + 1} - 1}{x} )$$

vi) at time t2, provide the second input value IN2 to the digital arctan function, yielding a second angle β=arctan(IN2);
vii) test if α≈2*β, and if the outcome of this test is false, an error is detected
   Example with Eq[5] and Only One Sensor or Two Sensors:

Such a diagnostic test is similar to the “diagnostic test based on equation [4] and only one sensor” or similar to the “diagnostic test based on equation [4] and two sensors”, except that the first input value IN1 is calculated as 2x, and the second input value IN2 is calculated as

$$IN 2 = ( \frac{\sqrt{4 {x}^{2} + 1} - 1}{2 x} )$$

While this embodiment can be used to diagnose certain functions of the sensor device, the angles α and β thus calculated are typically not the values of interest for the actual application (e.g. angular position to be determined), and thus an additional evaluation of arctan(x) may be required to obtain the angle α of interest.

Example with Eq[6]:

The same remarks as for the example with eq[5] are applicable.

Example with Eq[7]:

A diagnostic test based on equation [7], and using a sensor device having two sensors, may comprise the following steps:
i) measure two physical quantities using the two sensors;
ii) digitize the sensor signals, and call them x and y;
iii) if (y=0), skip the diagnostic test, otherwise continue;
iv) calculate IN1=x/y, and at time t1 apply the first input value IN1 to the digital arctan function, yielding a first angle α=arctan(x/y);
v) if (x≤0), calculate IN2 as

$$IN 2 = ( \frac{\sqrt{{x}^{2} + {y}^{2}} - x}{y} )$$

if (x>0), calculate IN2 as

$$IN 2 = ( \frac{y}{\sqrt{{x}^{2} + {y}^{2}} - x} )$$

vi) at time t2, provide the second input value IN2 to the digital arctan function, yielding a second angle β=arctan(IN2);
vii) test if α≈2*β, and if the outcome of this test is false, an error is detected.

In other or further variants of the embodiments described above, the sensor device comprises two sensor groups, e.g. a first sensor group configured for providing sensor signals s1, s2, and a second sensor group configured for providing sensor signals s3, s4. A first angle α may be calculated based on the first set of sensor signals s1, s2; and a second angle β may be calculated based on a second set of sensor signals s3, s4; and the consistency test may test a predefined mathematical relationship between the first angle and the second angle, taking into account a geometrical position of the respective sensor elements, e.g. an angular offset between the first sensor group and the second sensor group. Examples of such embodiments will be shown in FIG. 13A, FIG. 13B and FIG. 14.

FIG. 5 to FIG. 8 show illustrative examples of timing-diagrams that may be used in embodiments of the present invention, but of course, these are only examples, and other suitable timing schemes may also be used.

In FIG. 5, at time t0, one or more sensor signal(s) are obtained. At time t1 a first angle α is calculated by applying a first input value IN1 to the digital arctan function block. At time t2 a second angle β is calculated by applying a second input value IN2 to the digital arctan function block. At time t3 a consistency check of the first angle α and the second angle β is performed. At time t4 the value of the first angle α may be output, or the first angle α and also the second angle β, or the first angle α and an error signal E (e.g. the outcome of the consistency test). These steps may be performed repeatedly, e.g. periodically, in each time period ΔT, but as already mentioned above, that is not absolutely required, and it may suffice to perform a consistency test only in some periods, and skip the consistency test in other periods, or to perform the consistency test only for a certain value range.

FIG. 6 is a specific example of a timing diagram that may be applied in the sensor circuit of FIG. 4, or in the sensor circuits of FIG. 2 and FIG. 3 having at least two sensors and configured to perform a diagnostic test based on equations [2a],[2b].

FIG. 7 is a specific example of a timing diagram that may be applied in the sensor circuit of FIG. 4, or in the sensor circuits of FIG. 2 and FIG. 3 having at least two sensors and configured to perform a diagnostic test based on equations [2a],[2b]. In this example, in each time period ΔT, two signals are measured, but only one angle is calculated: in even numbered timeslots, the first angle α is calculated by applying a first input value IN1 to the digital arctan function block; in odd numbered timeslots, the second angle β is calculated by applying a second input value IN2 to the digital arctan function block. In the even numbered timeslots the angle α may be output, and in the odd numbered timeslots, an angle (90°−β) or (−90°−β) may be output, depending on the sign of the signals s1 and s2, as described above.

It is important to note that in this scheme, the first angle α is based on signals measured at time t6, whereas the second angle β is calculated based on signals measured at time t7, which are usually slightly different from the signals measured at time t6. The consistency check therefore may take into account a larger tolerance margin to cope not only with rounding errors, but also with a certain change of the angle over the time period ΔT. An advantage of this scheme is that it may allow to output the measured angle at a faster rate, while performing a consistency check in each timeslot, but as already mentioned above, that is not absolutely required.

In a variant (not shown) of FIG. 7, at time t6 two sensor signals s1, s2 are provided by a first sensor group, and a first angle α is calculated based on these signals s1, s2, e.g. in accordance with the formula α=arctan(s1/s2); and at time t7 two sensor signals s3, s4 are provided by a second sensor group, and a second angle β is calculated based on these signals s3, s4, e.g. in accordance with the formula β=arctan(s3/s4), and a consistency test may comprise testing if a difference between α and β is substantially equal (e.g. within a predefined tolerance margin of at most ±20° or at most ±15° or at most ±10°) to a predefined angular offset ψ. This offset value ψ may correspond for example with a geometric offset between the two sensor groups (e.g. as illustrated in FIG. 13A or FIG. 14), but of course other offset values different from 30° or 45° may also be used.

FIG. 8 shows another example of a timing scheme that may be applied for example in embodiments based on equations [5] or [6], where for example α and β are calculated to perform a consistency check as described above, but the angles α and β may not be the relevant angle for the application. However, by choosing IN3 equal to s1/s2, for example, and by calculating a third angle γ as arctan(IN3), the value of gamma γ may be the relevant angle for that application. In this example, the consistency check would be performed on the angles α and β. In a variant of FIG. 8, the order of calculating the three angles α, β, γ, may be changed. As explained above, it is not required to perform a consistency check in every time slot, in which case the calculation of α, and the calculation of β, and performing the consistency check may be skipped (as indicated in dotted lines).

FIG. 9 shows an example of a magnetic sensor system 910, comprising a permanent magnet 911 movably mounted with respect to a sensor device 900. The magnet may be a two-pole magnet, e.g. an axially or diametrically magnetized ring or disk magnet, or a two-pole bar magnet. The sensor device comprises a semiconductor substrate, and at least two magnetic sensor elements for measuring two orthogonal magnetic field components Bx, By oriented parallel to the semiconductor substrate.

In an example, the sensor device 900 comprises two vertical Hall elements, including a first vertical Hall element V1 having an axis of maximum sensitivity oriented in the X-direction, and a second vertical Hall element V2 having an axis of maximum sensitivity oriented in the Y-direction. The sensor element V1 provides a signal v1 indicative of the magnetic field component Bx, and the sensor element V2 provides a signal v2 indicative of the magnetic field component By.

In another example, the sensor device 900 comprises a disk shaped integrated magnetic concentrator (IMC) and four horizontal Hall elements H1 to H4 arranged near the periphery of the IMC, and angularly spaced by multiples of 90°. The sensor elements H1 to H4 provide sensor signals h1 to h4 respectively. The difference between the signals h0 and h2 is indicative for the magnetic field component Bx oriented in the X-direction. The difference between the signals h1 and h3 is indicative for the magnetic field component By oriented in the Y-direction.

As described above, a first angle α is calculated by applying a first input value IN1 equal to By/Bx to the digital arctan function block. A second angle β is calculated by applying a second input value IN2 equal to Bx/By to the digital arctan function block. Preferably the values of Bx, By are measured once, and stored in digital registers, such that the value of α and β are derived from the exact same numerical values. By doing so, the consistency test provides a specific test to verify correct operation of the “angle calculator” (and the routing path from the data registers to the angle calculator), but not the sensors. By testing whether the sum of α and β is equal to one of two predefined constants, within a predefined tolerance margin for coping with rounding errors, an error of the angle calculator can be detected. Other tests, e.g. as described above, using the sign( ) function, may also be used.

The block-diagram of FIG. 9 shows an angular position sensor system 910, wherein the magnet is rotatable about a rotation axis, and wherein the sensor device 900 is mounted in an “on-axis position” (i.e. located on the rotation axis), and wherein the sensor elements e.g. V1, V2 are configured for providing quadrature signals corresponding to orthogonal magnetic field components, but the present invention is not limited thereto, and also works for an angular position sensor system in which the sensor device is mounted in an “off-axis position” (i.e. at a non-zero radial distance from the rotation axis) and/or wherein the magnet is magnetized in a different direction (e.g. diametrically magnetized), and also works for linear position sensor systems.

FIG. 10 shows an example of another magnetic position sensor system 1010, which can be seen as a variant of the system 910 of FIG. 9. The sensor device 1000 comprises four horizontal Hall elements H1 to H4, located on a virtual circle. Each of these Hall elements is configured for measuring a magnetic field component Bz oriented perpendicular to the semiconductor substrate of the sensor device at the respective locations. It is possible to derive two quadrature signals, by calculating a first signal s1 as a difference (diff1) between the signals h1 and h3 obtained from the sensor elements H1 and H3 respectively, and by calculating a second signal s2 as a difference (diff2) between the signals h2 and h4 obtained from the sensor elements H2 and H4 respectively. It is noted that s1=(h1−h3) is proportional to the gradient signal dBz/dx, and that s2=(h2−h4) is proportional to the gradient signal dBz/dy.

The signals s1 and s2 allow not only to determine the angular position of the magnet relative to the sensor device, but also allow to perform a diagnostic test of the sensor device 1000, more specifically of the “angle calculator” thereof, comprising at least the digital divider and the arctan-function block (or routine), and depending on which formula is used, optionally furthermore also a square-root-function block (or routine) and/or a square function block (or routine), using the techniques described above. The formulas mentioned in FIG. 10 are based on eqs [2a], [2b] but the present invention is not limited thereto, and a consistency check based on the other equations mentioned above, is also possible for the sensor device of FIG. 10. It is noted that the gradient signals, and thus also the angle values derived therefrom, are highly insensitive to an external disturbance field, if present.

In preferred embodiments, the signals h1 and h3 are subtracted in the analog domain, and then amplified and digitized, and the result diff1 is stored in a first data register, and likewise the signals h2 and h4 are preferably subtracted in the analog domain, and then amplified and digitized, and the result diff2 is stored in a second data register. Thus, only two data registers are required.

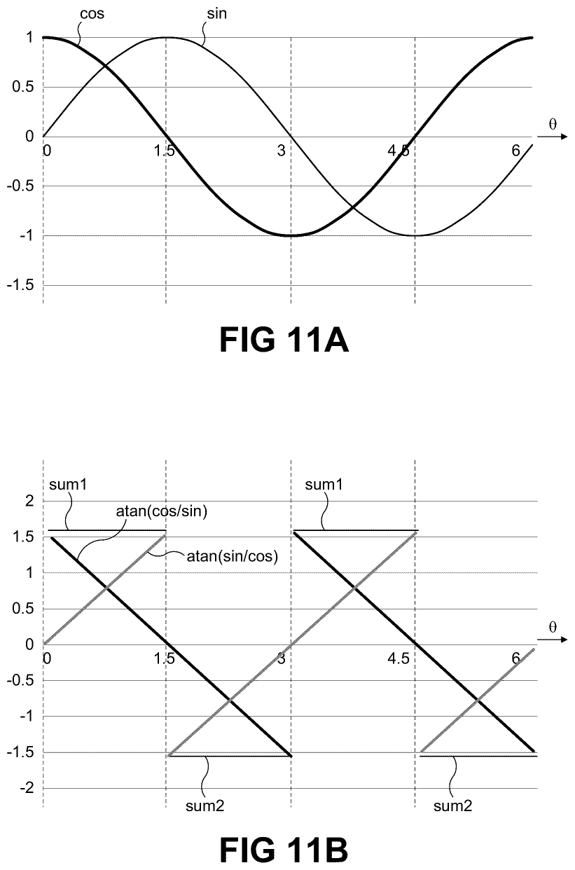

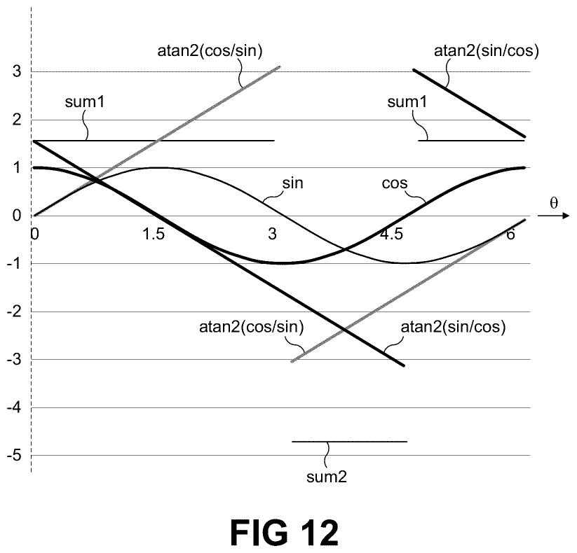

FIG. 11A shows an illustrative example of a sine and a cosine waveform as a function of angular displacement, as may be measured by the sensors of the sensor device of FIG. 9 or FIG. 10.

FIG. 11B shows that the sum of the two angles α=arctangent(By/Bx) and β=arctangent(Bx/By) is substantially equal to a first constant (+π/2) or a second constant (−π/2), assuming that the arctangent function returns a value in the range from −π/2 to +π/2.

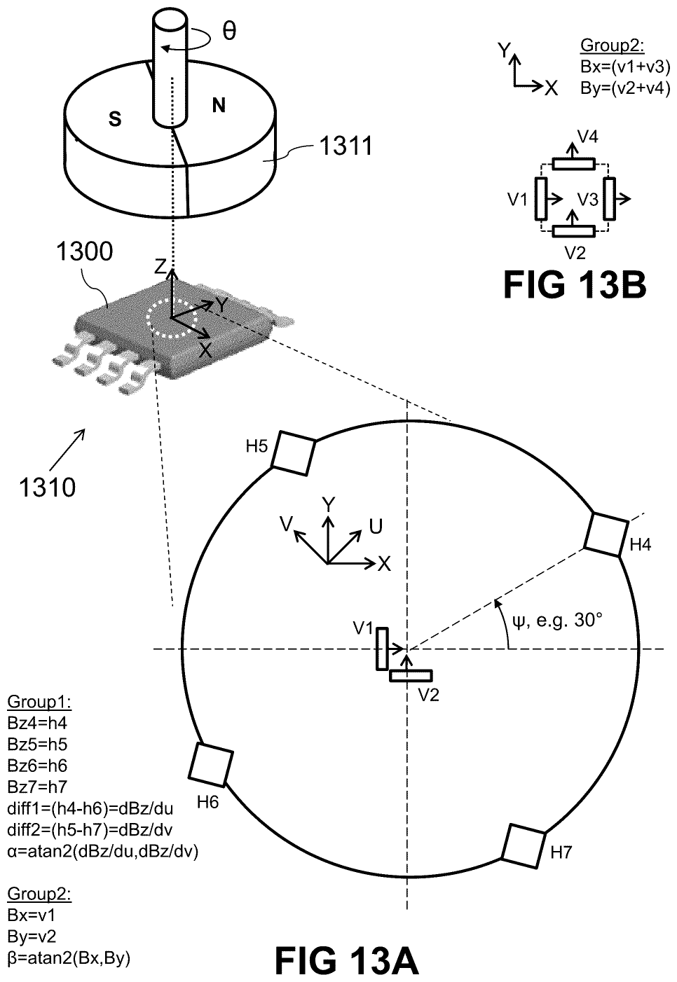

FIG. 12 shows a variant of FIG. 11B, in case the angle calculator returns a value in the range from −π to +π. Many of the same principles described above are also applicable here, except that the value of the predefined constants to be compared with the sum of α and β, are other values than those mentioned above. It is also noted that the region where sum1 is applicable is larger than the region where sum2 is applicable.

FIG. 13A shows an example of another magnetic position sensor system 1310, which can be seen as a variant of the system of FIG. 9, and as a variant of the system of FIG. 10. The system 1310 comprises a permanent magnet 1311 and a sensor device 1300. The sensor device comprises a semiconductor substrate with a first group of magnetic sensor elements H4 to H7 located on a virtual circle spaced apart by multiples of 90° configured for measuring Bz at the respective sensor locations, and a second group of magnetic sensor elements V1, V2 located substantially at the centre of the virtual circle, configured for measuring Bx, By. The sensor elements H4 to H7 provide sensor signals h4 to h7, respectively, and the sensor elements V1 and V2 provide sensor signals v1 and v2 respectively.

As explained in FIG. 9, the angular position θ of the magnet 1311 relative to the sensor device 1300 can be derived from the signals v1, v2 obtained from the sensor elements located at the centre, and integrity of the “angle calculator” of the sensor device 1300 can be verified based on these signals (alone). As explained in FIG. 10, the angular position θ of the magnet 1311 relative to the sensor device 1300 can also be derived from the signals h4 to h7 obtained from the sensor elements H4 to H7 located on the virtual circle, and integrity of the angle calculator of the sensor device 1300 can also be tested based on these signals (alone). But since the sensor elements of the first sensor group and the second sensor group define a predefined angular displacement ψ, there is a mathematical relationship between the angles α and β and ψ. By taking furthermore into account that the integrity check can be based on several formulas (see equation [1] to [7] mentioned above), it will be appreciated that the diagnostic test can also be performed by comparing a first angle α derived from the signals obtained from the first group of sensors, and a second angle β derived from the signals obtained from the second group of sensors, or vice versa, and taking into account the angular offset or shift ψ between the first group of sensors and the second group of sensors, which in the example of FIG. 13A amounts to 30°, but of course the present invention is not limited thereto, and other angular offset or shifts can also be used, e.g. 20° or 40° or 45°, etc. It is a major advantage of such embodiments that not only the arctan function block and the divider block can be tested, but also the magnetic sensors.

A few examples are given below:

In an embodiment, the first angle α is calculated as a tan 2(dBz/du,dBz/dv), and the second angle β is calculated as a tan 2(Bx,By), and in the diagnostic test it is tested whether α and β are phase shifted over the angular offset ψ (e.g. 30°) between the first group and the second group of sensors, taking into account a tolerance margin e.g. for rounding errors, for an influence from an external disturbance field, or a latency between the two measurements, etc.

In another embodiment, the first angle α is calculated as a tan 2(dBz/du,dBz/dv), and the second angle β is calculated as a tan 2(By,Bx), and in the diagnostic test it is tested whether the sum of α and β is substantially equal to a first predefined value of (−90°+30°)=−60° or to a second predefined value of (+90°+30°)=120°.

In another embodiment, the first angle α is calculated as a tan 2(dBz/du,dBz/dv), and the second angle β is calculated as 2*arctan [(sqrt(x*x+1)−1)/x], wherein x is set to Bx/By, and wherein the diagnostic test comprises verifying whether α is substantially equal to (β+30°) within a predefined tolerance margin of e.g. ±10°.

In an embodiment, the first angle α is calculated as a tan 2(dBz/dv,dBz/du), and the second angle β is calculated as a tan 2(By,Bx), and in the diagnostic test it is verified whether α and β are substantially phase shifted over the angular offset between the first and second sensor group (e.g. 30°).

In an embodiment, the first angle α is calculated as arctan [(sqrt(x*x+1)−1)/x], wherein x is set to (h4−h6)/(h5−h7), and the second angle β is calculated as a tan 2(v1,v2), and in the diagnostic test it is verified whether (2*α) and β are substantially phase shifted over the angular offset between the first and second sensor group (e.g. 30°).

Similar as described in FIG. 10, in preferred embodiments, the signals h4 and h6 obtained from H4 and H6 are subtracted in the analog domain, and this difference signal is amplified and digitized. In this way the signals from H4 and H6 are highly consistent (captured at the same moments in time). Likewise, the signals h5 and h7 obtained from H5 and H7 are subtracted in the analog domain, and this difference signal is amplified and digitized. By doing so, an external disturbance field, even an external disturbance field that changes quickly over time, is strongly reduced or even completely eliminated. This is true, even if the signals diff1 and diff2 are not captured at the same time, but one after the other.

In a variant of FIG. 13A, the second group of sensors comprises four vertical Hall elements V1 to V4 arranged on the sides of a virtual square, as illustrated in FIG. 13B. This virtual square would be located at the centre of the circle of FIG. 13A. A first signal s1 can be derived from the sensor signals as (v1+v3), which is proportional to Bx. A second signal s2 can be derived from the sensor signals as (v2+v4), which is proportional to By. The signals s1 and s2 have substantially the same amplitude and are substantially 90° phase shifted, i.e. they are quadrature signals.

FIG. 14 shows another variant of the sensor system of FIG. 13A, wherein each of the horizontal Hall elements H4 to H7 of the first group of sensors is replaced by a pair of two horizontal Hall elements (e.g. H4 of FIG. 13A is replaced by HP4a and HP4b in FIG. 14) the signals of which are combined to improve the signal-to-noise ratio (SNR); and wherein the vertical Hall elements of the second group of sensors located at the centre of the circle are replaced by an integrated magnetic concentrator (IMC) and four horizontal Hall elements (not shown), or four pairs of horizontal Hall elements HP0a to HP3b (as shown), arranged near the periphery of the IMC, the pairs being angularly spaced by multiples of 90°. In the example shown in FIG. 14, the first and second group of sensors are angularly shifted by an offset ψ=45°, but as mentioned for FIG. 13A, that is not absolutely required, and other angular offsets can also be used, for example any angular offset in the range from 5° to 85°, or in the range from from 10° to 80°, e.g. equal to about 10° or 15° or 20°. Everything else described above for the system of FIG. 13A is also applicable here, mutatis mutandis.

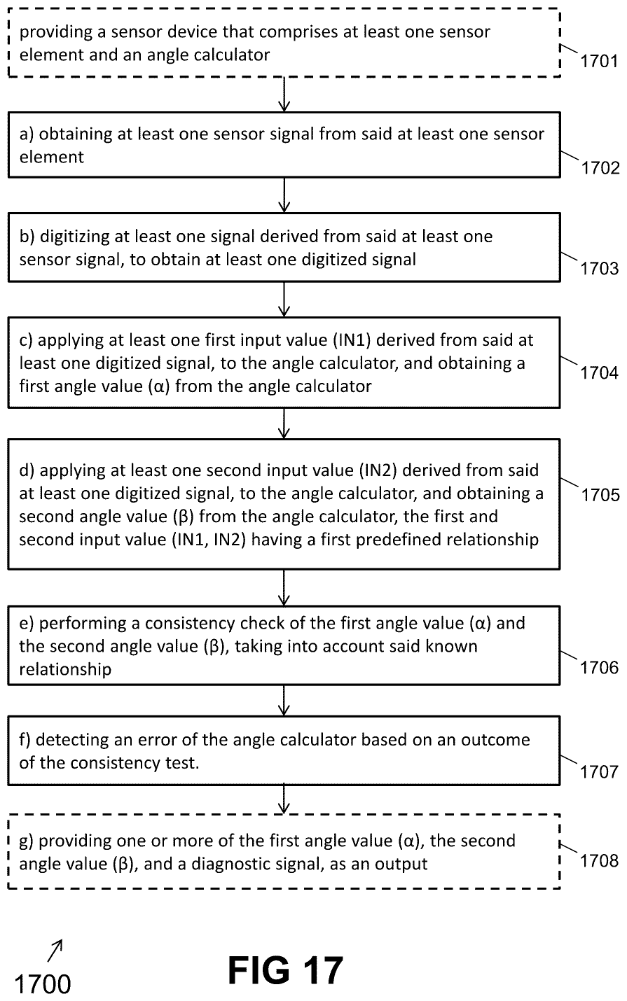

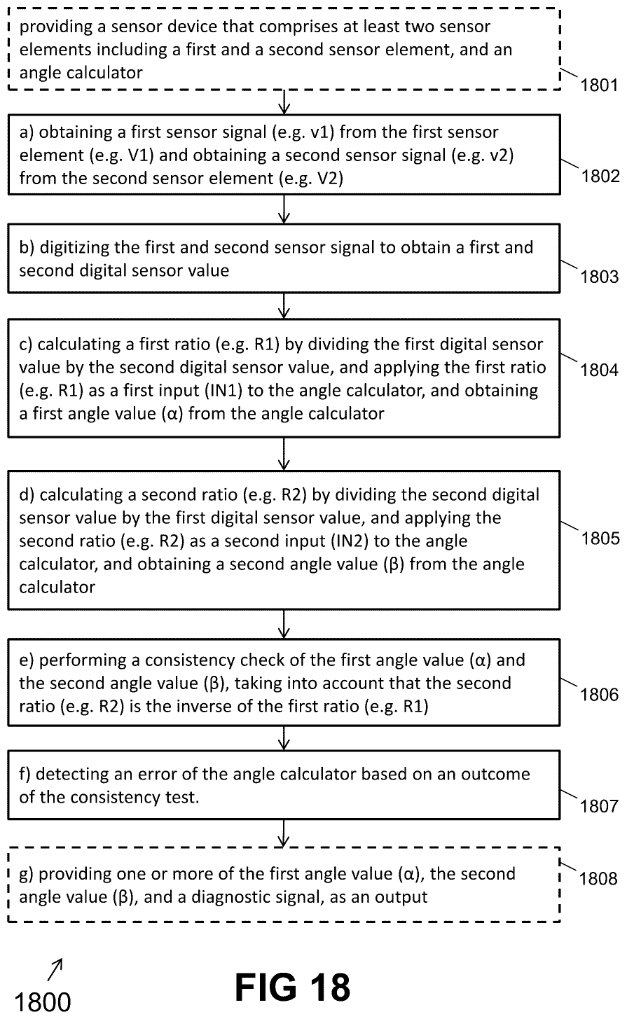

FIG. 15A shows an example of waveforms as may be obtained from the sensor elements of FIG. 13A or FIG. 14 or derived therefrom.

FIG. 15B shows that the sum of arctangent(Bx/By) and arctangent[(dBz/dv),(dBz/vu)] is substantially equal to a first predefined constant (sum1) or a second predefined constant (sum2).

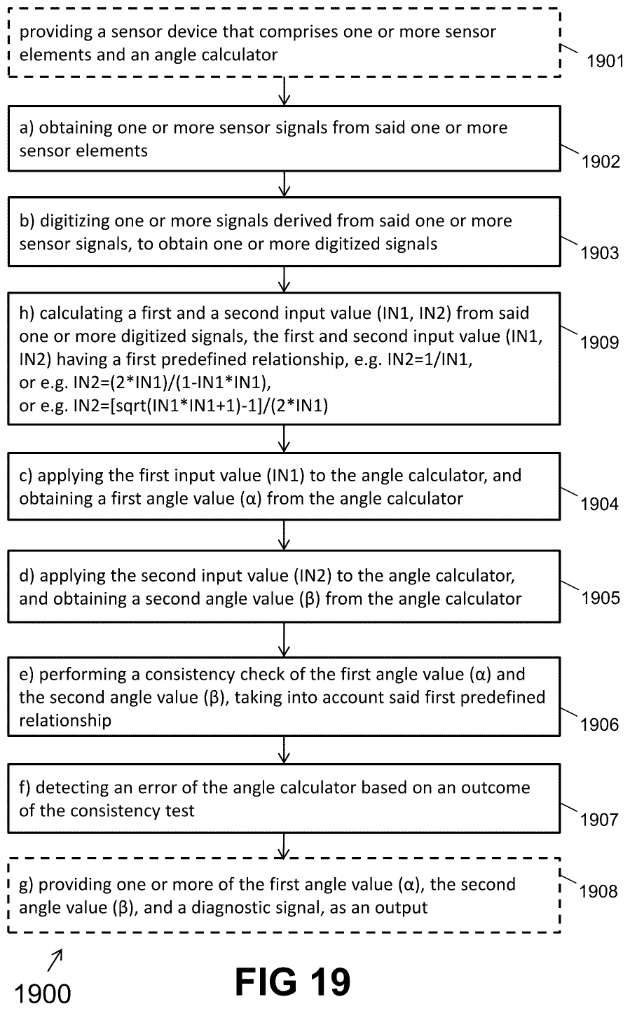

FIG. 16 shows a variant of FIG. 15B, in case the arctangent function returns a value in the range from −π to +π.

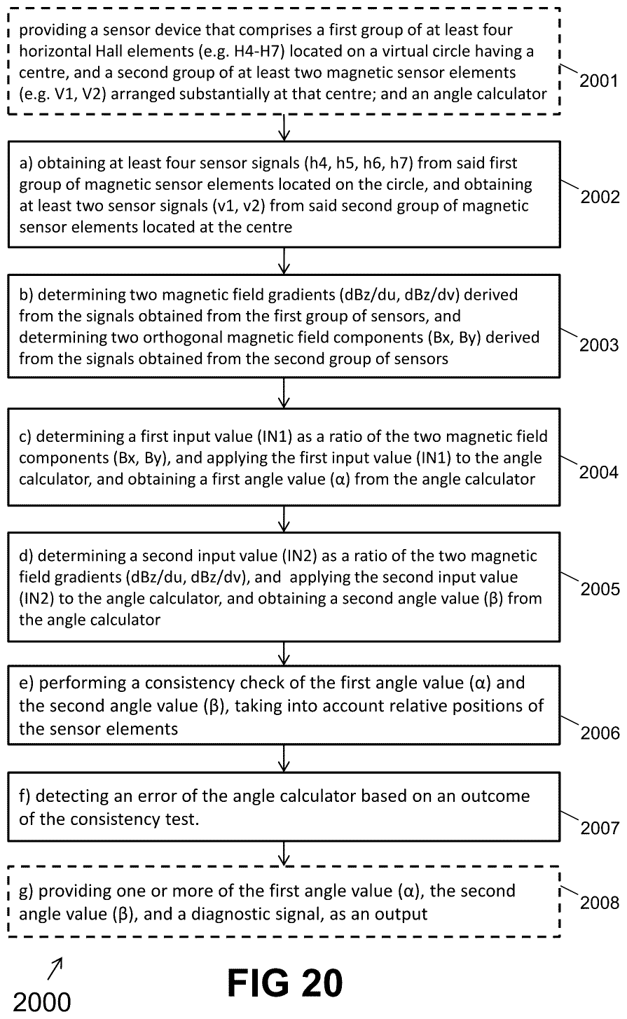

FIG. 17 shows a flow-chart of a method 1700 of testing a sensor device that comprises at least one sensor element and an angle calculator (e.g. in the form of a block or circuit or routine that performs an arctan function or an a tan 2 function). The method 1700 comprises the following steps:
a) obtaining 1702 at least one sensor signal from said at least one sensor element;
b) digitizing 1703 said at least one sensor signal or digitizing at least one signal derived from said at least one sensor signal, to obtain at least one digitized signal;
c) applying 1704 at least one first input value (IN1) derived from said at least one digitized signal, to the angle calculator, and obtaining a first angle value (α) from the angle calculator;
d) applying 1705 at least one second input value (IN2) derived from said at least one digitized signal, to the angle calculator, and obtaining a second angle value (β) from the angle calculator, the first and second input value (IN1, IN2) having a first predefined relationship;
e) performing 1706 a consistency check of the first angle value (α) and the second angle value (β), taking into account said first predefined relationship, e.g. based on a second predefined relationship corresponding to the first predefined relationship;
f) detecting an error of the angle calculator based on an outcome of the consistency test.

In preferred embodiments, some or all of these steps are performed periodically. The steps a) to c) are preferably performed in each period. The steps d) to f) do not need to be performed in each period, although they may. The decision on whether or not to perform the steps d) to f) may be predefined (e.g. once in every 10 periods, or once in every 100 periods), and/or may depend on the value of the digitized signal.

The method may further comprise a step 1701 of providing a sensor device that comprises at least one sensor element and an angle calculator.

The method may further comprise a step g) of providing 1708 one or more of the first angle value (α), the second angle value (β), and a diagnostic signal, as an output.

In an embodiment, all of the steps are performed by the sensor device itself.

In another embodiment, some of the steps are performed by the sensor device, e.g. steps a) to d), while other steps, e.g. step e) and f) are performed by another processing device, e.g. an electronic control unit (ECU) communicatively connected to the sensor device. In this case, both angle values need to be output in step g).

Step d) and step e) may be based on one or more of the mathematical equations listed above, in particular when discussing FIG. 4.

FIG. 18 shows a flow-chart of a method 1800 of testing a sensor device that comprises at least two sensor element (e.g. V1, V2) and an angle calculator (e.g. in the form of a block or circuit or routine that performs an arctan function or an a tan 2 function). This method can be regarded as a special case of the method 1700 of FIG. 17. Preferably the sensor signals are chosen such that their amplitudes are substantially the same (within ±5%), and their phase is approximately 90° phase shifted (within ±5°), i.e. that the signals are substantially quadrature signals. The method 1800 comprises the following steps:
a) obtaining 1802 a first sensor signal (e.g. v1) from the first sensor element (e.g. V1) and obtaining a second sensor signal (e.g. v2) from the second sensor element (e.g. V2);
b) digitizing 1803 the first and the second sensor signal to obtain a first and a second digital sensor value;
c) calculating 1804 a first ratio (e.g. R1) by dividing the first digital sensor value by the second digital sensor value, and applying the first ratio (e.g. R1) as a first input (IN1) to the angle calculator, and obtaining a first angle value (α) from the angle calculator;
d) calculating 1805 a second ratio (e.g. R2) by dividing the second digital sensor value by the first digital sensor value, and applying the second ratio (e.g. R2) as a second input (IN2) to the angle calculator, and obtaining a second angle value (β) from the angle calculator;
e) performing 1806 a consistency check of the first angle value (α) and the second angle value (β), taking into account that the second ratio (e.g. R2) is the inverse of the first ratio (e.g. R1);
f) detecting 1807 an error of the angle calculator based on an outcome of the consistency test.

The method may further comprise a step 1801 of providing a sensor device that comprises at least two sensor elements and an angle calculator.

The method may further comprise a step g) of providing 1808 one or more of the first angle value (α), the second angle value (β), and a diagnostic signal, as an output.

As mentioned above (FIG. 17),
some or all of these steps are performed periodically;
it is not required that the steps d) to f) are performed in each period;
in an embodiment, all of the steps are performed by the sensor device itself.
in another embodiment, some of the steps are performed by the sensor device, e.g. steps a) to d), while other steps, e.g. step e) and f) are performed by another processing device.
   Step d) and step e) may be based on one or more of the mathematical equations listed above, in particular when discussing FIG. 4.

FIG. 19 shows a flow-chart of a method 1900 of testing a sensor device that comprises at least one sensor element, or at least two sensor elements and an angle calculator (e.g. in the form of a block or circuit or routine that performs an arctan function or an a tan 2 function). This method can be seen as a variant of FIG. 17. The method 1900 comprises the following steps:
a) obtaining 1902 one or more sensor signals from said one or more sensor elements;
b) digitizing 1903 one or more signals derived from said one or more sensor signals, to obtain one or more digitized signals;
h) calculating 1909 a first and a second input value (IN1, IN2) from said one or more digitized signals, the first and second input value (IN1, IN2) having a first predefined mathematical relationship,

$$e . g . I N 2 = ( 1 / IN 1 ) , or$$

$$e . g . IN 2 = ( 2 * IN 1 ) / ( 1 - IN 1 * IN 1 ) , or$$

$$e . g . IN 2 = [ sqrt ( IN 1 * IN 1 + 1 ) - 1 ] / ( 2 * IN 1 ) ;$$

c) applying the first input value (IN1) to the angle calculator, and obtaining a first angle value (α) from the angle calculator;
d) applying 1905 the second input value (IN2) to the angle calculator, and obtaining a second angle value (β) from the angle calculator;
e) performing 1906 a consistency check of the first angle value (α) and the second angle value (β), taking into account said first predefined relationship;
f) detecting 1907 an error of the angle calculator based on an outcome of the consistency test.

In practical implementations, step h) may comprise: calculating the first input value IN1, and checking if certain conditions are met (e.g. test if IN1< >0) before calculating IN2, but these are implementation details, which need not be spelled out in detail.

In preferred embodiments, some or all of these steps are performed periodically. The steps d), e) and f) do not need to be performed in each period, although they may.

The method may further comprise a step 1901 of providing a sensor device that comprises at least one sensor element and an angle calculator, e.g. a single angle calculator.

The method may further comprise a step g) of providing 1908 one or more of the first angle value (α), the second angle value (β), and a diagnostic signal, as an output.

In an embodiment, all of the steps are performed by the sensor device itself.

In another embodiment, some of the steps are performed by the sensor device, e.g. steps a), b), h), c) and d), while other steps, e.g. step e) and f) are performed by another processing device, e.g. an electronic control unit (ECU) communicatively connected to the sensor device. In this case, both angle values need to be output in step g).

FIG. 20 shows a flow-chart of a method 2000 of testing a sensor device that comprises a first group of at least four horizontal Hall elements (e.g. H4-H7) located on a virtual circle having a centre, and a second group of at least two magnetic sensor elements (e.g. V1, V2) arranged substantially at that centre, e.g. as illustrated in FIG. 13A or FIG. 14; and that comprises an angle calculator (e.g. in the form of a block or circuit or routine that performs an arctan function or an a tan 2 function). This method can be seen as a special case of the method shown in FIG. 17 or in FIG. 19. The method 2900 comprises the following steps:
a) obtaining 2002 at least four sensor signals (h4, h5, h6, h7) from said first group of magnetic sensor elements located on the circle, and obtaining at least two sensor signals (v1, v2) from said second group of magnetic sensor elements located at the centre;
b) determining 2003 two magnetic field gradients (dBz/du, dBz/dv) derived from the signals obtained from the first group of sensors, and determining two orthogonal magnetic field components (Bx, By) derived from the signals obtained from the second group of sensors;
c) determining 2004 a first input value (IN1) as a ratio of the two magnetic field components (Bx, By), and applying the first input value (IN1) to the angle calculator, and obtaining a first angle value (α) from the angle calculator;
d) determining 2005 a second input value (IN2) as a ratio of the two magnetic field gradients (dBz/du, dBz/dv), and applying the second input value (IN2) to the angle calculator, and obtaining a second angle value (β) from the angle calculator;
c) performing 2006 a consistency check of the first angle value (α) and the second angle value (β), taking into account relative positions of the sensor elements;
f) detecting 2007 an error of the angle calculator based on an outcome of the consistency test.

The method may further comprise a step 2001 of providing a sensor device that comprises at least one sensor element and an angle calculator.

The method may further comprise a step of providing a sensor device that comprises a first group of at least four horizontal Hall elements (e.g. H4-H7) located on a virtual circle having a centre, and a second group of at least two magnetic sensor elements (e.g. V1, V2) arranged substantially at that centre, and an angle calculator.

The method may comprise a step g) of providing 2008 one or more of the first angle value (α), the second angle value (β), and a diagnostic signal, as an output.

The same or similar remarks as described above for the method 1700 of FIG. 17 and/or for the method 1900 of FIG. 19 are also applicable here, mutatis mutandis.

While the principles of the present invention have been described above mainly for sensor devices having only a single angle calculator block, the same or similar principles can also be applied in sensor devices having two angle calculators, e.g. to detect a “common-cause failing mode”. Prior art solutions with two angle calculators typically provide two parallel data-paths: a main path providing a first angle, and a redundant path providing a second angle; and wherein the two paths are followed by a verification block which checks if both angular values are substantially the same, and if they are not, has detected an error. In contrast, using the principles of the present invention described above, one signal path would be fed with a first input IN1, and the other signal path would be fed with a second input IN2, usually different from IN1, except for rare cases; and the verification block would not test whether both angular values are substantially the same, but would test whether the two angles satisfy a second predefined relationship, e.g. as described above. The same equations [1] to [7], or other equations, can be used also in this case. And also in this case, the actual verification may be performed outside of the sensor device, e.g. in an ECU.

While individual features are explained in different drawings and in different embodiments of the present invention, it is contemplated that features of different embodiments can be combined, as would be obvious to the skilled person, when reading this document.

1. A method of testing an angle calculator implemented in a magnetic position sensor device that comprises at least a first and a second magnetic sensor element and a single angle calculator, the method comprising the steps of:
a) obtaining a first signal provided by at least the first magnetic sensor element, and obtaining a second signal provided by at least the second magnetic sensor element;
b) amplifying and digitizing the first signal to obtain a first digital signal, and amplifying and digitizing the second signal to obtain a second digital signal;
c) deriving a first input value or a first set of input values from said first and second digital signal, and applying this first input value or this first set of input values to the angle calculator, and obtaining a first angle value from the angle calculator;
d) deriving a second input value or a second set of input values from said first and second digital signal, and applying this second input value or this second set of input values to the angle calculator, and obtaining a second angle value from the angle calculator, wherein the first and second input value or the first set and the second set of input values have a first predefined mathematical relationship;
e) performing a consistency test of the first angle value and the second angle value based on a second predefined mathematical relationship, associated with the first predefined relationship;
f) detecting an error of the single angle calculator based on an outcome of the consistency test.

2. The method according to claim 1, wherein the angle calculator is configured to estimate or to determine an arctangent function with one argument or an arctangent function with two arguments.

3. The method according to claim 1, wherein step b) further comprises: storing the first digital signal in a first data register, and storing the second digital signal in a second data register; and
wherein the first input value or the first set of input values of step c), and the second input value or the second set of input values of step d) are derived from the same numerical values as those stored in the first and second data register.

4. The method according to claim 1, wherein the angle calculator comprises a divider and an arctangent calculator; and
wherein step c) comprises: calculating the first input value by dividing the first digital signal by the second digital signal, and providing the first input value to the arctangent calculator for calculating the first angle value; and
wherein step d) comprises: calculating the second input value by dividing the second digital signal by the first digital signal, and providing the second input value to the arctangent calculator for calculating the second angle value; and
wherein step e) comprises: testing whether a sum of the first angle value and the second angle value is substantially equal to a first or a second predefined constant within a predefined tolerance margin.

5. The method according to claim 4, wherein step e) comprises: testing if said sum is substantially equal to +90° in case a sign of the first digital sensor value and a sign of the second digital sensor value are equal; and testing if said sum is substantially equal to −90° in case the sign of the first digital sensor value and the sign of the second digital sensor value are different.

6. The method according to claim 1, wherein the angle calculator comprises a divider and an arctangent calculator; and
wherein step c) comprises: calculating the first input value IN1 by dividing the first digital signal by the second digital signal, and providing the first input value IN1 to the arctangent calculator for calculating the first angle value (α); and
wherein the method further comprises a step of testing whether an absolute value of the first input value IN1 is smaller than 1.0, and
if an outcome of this test is false, skipping steps d) to step f), and
if the outcome of this test is true, calculating in step d) the second input value IN2 in accordance with the formula IN2=2*IN1/(1−IN1*IN1), and testing in step e) whether the first angle value is substantially equal to the second angle value divided by 2.0.

7. The method according to claim 1, wherein the angle calculator comprises a divider and an arctangent calculator; and
wherein step c) comprises: calculating the first input value IN1 by dividing the first digital signal by the second digital signal, and providing the first input value IN1 to the arctangent calculator for calculating the first angle value; and
wherein step d) comprises: calculating the second input value IN2 in accordance with the formula IN2=(sqrt(IN1*IN1+1)−1)/IN1, and testing in step e) whether the first angle value is substantially equal to the second angle value.

8. The method according to claim 1, wherein the angle calculator comprises a divider and an arctangent calculator; and
wherein step c) comprises: calculating the first input value IN1 as N times the first digital signal, or as N times the second digital signal, or as N times the first digital signal divided by the second digital signal, and providing the first input value IN1 to the arctangent calculator for calculating the first angle value,
wherein N is a predefined number; and
wherein step d) comprises: calculating the second input value IN2 in accordance with the formula IN2=(sqrt(N*N*IN1*IN1+1)−1)/(N*IN1), and testing in step e) whether the first angle value is substantially equal to 2.0 times the second angle value.

9. A method of testing a magnetic position sensor device that comprises an angle calculator and a first group and a second group of magnetic sensors,
wherein the first group of magnetic sensors is configured for providing a first set of quadrature signals comprising a first signal and a second signal indicative of orthogonal magnetic field components, and
wherein the second group of magnetic sensors is configured for providing a second set of quadrature signals comprising a third signal and a fourth signal indicative of magnetic field gradients along two perpendicular directions having a predefined angular offset relative to the first direction in the range from 5° to 85°, the method comprising the steps of:
a) obtaining the first and the second signal from the first group of magnetic sensors;
b) amplifying and digitizing the first signal to obtain a first digital signal, and amplifying and digitizing the second signal to obtain a second digital signal;
c) deriving a first input value or a first set of input values from said first and second digital signal, and applying this first input value or this first set of input values to the angle calculator, and obtaining a first angle value from the angle calculator;
d) obtaining the third and the fourth signal from the second group of magnetic sensors;
e) amplifying and digitizing the third signal to obtain a third digital signal, and amplifying and digitizing the fourth signal to obtain a fourth digital signal;
f) deriving a second input value or a second set of input values from said third and fourth digital signal, and applying this second input value or this second set of input values to the angle calculator, and obtaining a second angle value from the angle calculator;
g) performing a consistency test of the first angle value and the second angle value based on a predefined mathematical relationship that takes into account said predefined angular offset;
h) detecting an error of the magnetic position sensor device based on an outcome of the consistency test.

10. The method according to claim 9, wherein the first group comprises at least four horizontal Hall elements located on a virtual circle having a centre, and
wherein the second group comprises at least two magnetic sensor elements arranged substantially at the centre of said virtual circle; and
wherein the angle calculator comprises a divider and an arctangent calculator; and
wherein step c) comprises: calculating the first input value by dividing the first digital signal by the second digital signal, and providing the first input value to the arctangent calculator for calculating the first angle value; and
wherein step d) comprises: calculating the second input value by dividing the third digital signal by the fourth digital signal, and providing the second input value to the arctangent calculator for calculating the second angle value; and
wherein step g) comprises: testing if the sum of the first angle value and said predefined angular offset is substantially equal to the second angle value, or
wherein step g) comprises: testing if the sum of the first angle and the second angle value is substantially equal to a first or a second predefined constant.

11. The method according to claim 10, wherein step g) comprises: testing if the sum of the first angle and the second angle value minus the predefined angular offset is substantially equal to +90° or substantially equal to −90°.

12. The method according to claim 9, further comprising one or more of the following features:
i) wherein the second group of sensor elements comprises two vertical Hall elements oriented with their axis of maximum sensitivity in orthogonal directions;
ii) wherein the first group of sensor elements comprises four horizontal Hall elements arranged near an edge of an integrated magnetic concentrator (IMC), angularly spaced apart by multiples of 90°;
iii) wherein the first group of sensor elements comprises four horizontal Hall elements arranged on the virtual circle, and spaced apart by multiples of 90°;
iv) wherein the predefined angular offset is equal to 0° or is equal to 90° or is equal to 45°.

13. A magnetic sensor device comprising:
a single angle calculator;
at least two magnetic sensor elements or at least two groups of magnetic sensor elements;
a processing circuit configured for performing a method according to claim 1.

14. A magnetic position sensor system comprising:
a magnetic sensor device according to claim 13;
a permanent magnet movably mounted relative to the sensor device.
